(19) United States
(12) Patent Application Publication
(10) Pub. No.: US 2024/0420598 A1
(43) Pub. Date: Dec. 19, 2024

(54) MULTI-LAYER ADHERING LABEL

(71) Applicant: InterDesign, Inc., Solon, OH (US)

(72) Inventors: James Gallagher, Gates Mills, OH (US); Emily Fano, Parma, OH (US); Jinhua Wang, Guangzhou (CN); Michael Scherzer, Stevensville, MI (US)

(21) Appl. No.: 18/520,940

(22) Filed: Nov. 28, 2023

Related U.S. Application Data
(60) Provisional application No. 63/521,789, filed on Jun. 19, 2023.
(60) Provisional application No. 63/583,418, filed on Sep. 18, 2023.

(51) Int. Cl. G09F 3/02

(52) U.S. Cl. CPC G09F 3/02; G09F 2003/0222; G09F 2003/0257; G09F 2003/0272

(57) ABSTRACT

A multi-layer adhering label comprising a removable retail label having a first adhesive on its back side and a consumer label having a front surface capable of being written on with a writing instrument and an area for writing with the writing instrument and having a second adhesive on its back side. The back of the retail label is adhered to, and removable from, the front of the consumer label. The retail label covers at least a portion of the consumer label, carries the consumer label, and is removable from the consumer label. The area for writing of the front of the consumer label side can be written on with permanent marker (e.g., SHARPIE brand) and permanent marker writing can be removed from the front of the consumer label with a solvent.

### CROSS-REFERENCE TO RELATED CASES

This case claims priority to, and all other benefit of, U.S. Application Ser. No. 63/521,789, filed Jun. 19, 2023 (Attorney Docket No. 34922.05195), and U.S. Application Ser. No. 63/583,418, filed Sep. 18, 2023 (Attorney Docket No. 34922.05203), the entire disclosures of which are hereby incorporated by reference in their entireties.

### FIELD

The inventive concepts disclosed herein relate generally to a multi-layer label, and more particularly, to a multi-layer adhering label comprising a removable first label covering at least a portion of a second label having an area for writing with a writing instrument. The inventive concepts disclosed herein also relate generally to an object, such as a bin or other container, having a multi-layer adhering label affixed thereto, a kit comprising instructions for use of a multi-layer adhering label, and methods of applying a multi-layer adhering label to an object, such as a bin or other container.

### BACKGROUND

Pre-printed labels that can be applied directly onto the surface of a product prior to commercial sale are generally known in in the art. Traditional pre-printed labels are single-layer labels comprising a front side depicting retail or marketing information, such as brand names, product specifications, and UPC codes thereon, with an adhesive back side for affixing to the product. It is also generally known that certain products may be used for organizational purposes and to store items, including in the home, office, or garage. Consumers may purchase certain products commonly used for home organization, e.g., bins (e.g., made of transparent and/or opaque and/or translucent plastic, such as PET, or made of wire with a planar plate), other holders, shelves, organizers, and other such objects, to contain the items in their living spaces. Furthermore, it is advantageous for users to be able to identify the contents of their home organization products, traditionally by affixing their own labels to the outside surface of the product and marking or writing on said affixed labels to identify the contents stored within the product.

### SUMMARY

Applicant has realized that there is an unmet need for a multi-layer label comprising a first pre-printed removable label with a second label thereunder having an area for writing with a writing instrument (e.g., a blank second label), such that the multi-layer label can serve as a retail label at the point of sale, and once the removable first label is removed by the consumer, will allow said consumer to mark on the second blank label in order to identify the contents of the product to which the multi-layer label is affixed. In some exemplary embodiments, the second label has an area for writing that is at least 50% blank, e.g., at least 75% blank or entirely blank. In other exemplary embodiments, the second label has an area for writing with some printing on it that is light enough so as not to obscure writing with a pen or permanent marker, e.g., a lightly printed pattern or image covering at least 50% or covering at least 75% or covering the entire second label. In some exemplary embodiments, the removable first label further comprises instructions for a user to remove the removable first label from the object or bin (e.g., “peel here” or other instructions to remove the removable first label, printed on the removable first label itself such as on a corner), permitting the user to write on the second label, which is still on the object or bin.

Various embodiments described herein are directed to a multi-layer adhering label, or an object, such as a bin, having such a multi-layer adhering label attached thereto. The multi-layer adhering label comprises a removable first label having a retail front side and a first back side. The first back side includes a first adhesive on at least part of the first back side. The multi-layer adhering label also comprises a second label having a second front side and a second back side. The second front side includes an outer surface capable of being written on with a writing instrument, wherein at least 50% of the second front side provides an area for writing with the writing instrument. In exemplary embodiments, the writing can be removed. The second label includes means for attaching the second label to an object, such as the bin, on at least part of the back side of the second label, and the first back side is adhered to, and removable from, at least one of the second front side or the object. The first back side covers at least a portion of the second front side of the second label and the removable first label carries the second label.

The present application further discloses various embodiments directed to a multi-layer adhering label, or an object, such as a bin, having such a multi-layer adhering label attached thereto. The multi-layer label comprises a removable first label having a retail front side and a first back side. The first back side includes a first adhesive on at least part of the first back side. The multi-layer adhering label also comprises a second label having a second front side and a second back side. The second front side includes an outer surface capable of being written on with a writing instrument, wherein at least 50% of the second front side provides an area for writing with the writing instrument. The second label includes means for attaching the second label to an object, such as the bin, on at least part of the back side, wherein the first back side is adhered to, and removable from, at least one of the second front side or the object The first back side covers at least a portion of the second label and the removable first label carries the second label. The means for attaching the second label permits the second label to be removed from a surface of the object and repositioned on the same or another surface of the object (the same surface or a different surface of the object).

In exemplary embodiments, the removable first label covers the second front side of the second label. In exemplary embodiments, the first adhesive of the removable first label is removably adhered to at least 10% of the area of the second label second front side. In exemplary embodiments, the entire second front side of the second label is adhered to, and removable from, the first adhesive of the removable first label. In exemplary embodiments, the first adhesive is on only a perimeter of the first back side, or a portion of the perimeter of the first back side (e.g., only on upper and lower edges or only on left and right edges), leaving at least a central region of the first back side without adhesive. In exemplary embodiments, the first adhesive is on only a perimeter of the first back side, or a portion of the perimeter of the first back side (e.g., only on upper and lower edges or only on left and right edges, only on the left and right sides, or only in the corners), leaving at least a central region of the first back side at least as large as the second label without adhesive so that the removable first label can cover the second front side of the second label without adhering thereto. In exemplary embodiments, there is adhesive only on the outer corners of the first back side of the removable first label. In exemplary embodiments, there is no adhesive on at least one of the corners of the first back side of the removable first label covering a portion of the second label so that when that corner is removed, no adhesive of the first back side lifts up a corresponding corner of the second label underneath. In some exemplary embodiments, the first back side of the removable first label comprises a first adhesive and further comprises an adhesive reducing barrier in at least one region on the first back side of the removable first label. This allows labels that already have adhesive on their backs to be used (the adhesive reducing barrier is applied over the existing adhesive layer), which is more cost effective than trying to apply adhesive to less that the entire label back leaving one or more regions without adhesive. In some exemplary embodiments, the adhesive reducing barrier is a very thin layer of a material, such as varnish or silicone oil, applied as to at least one region of the adhesive on the first back side. In exemplary embodiments, the adhesive reducing barrier is printed onto the adhesive of the first back side like ink would be printed. In exemplary embodiments, the silicone oil is applied as a varnish. In exemplary embodiments, the adhesive reducing barrier (e.g., silicone oil or varnish) has a matte finish. In exemplary embodiments, the adhesive reducing barrier is any one or more of low odor, wear-resistant, high-gloss and high-transparency. In exemplary embodiments, the adhesive reducing barrier comprises silicone oil in the form of flexo printing ink. Exemplary embodiments with an adhesive reducing barrier applied permit the removable first label to be removed more easily from the second label by putting a barrier between the adhesive and the second label. In the alternative, the region or adhesive reducing barrier is printed on the front of the second label instead of or in addition to a region or adhesive reducing barrier applied to the back of the removable first label. In exemplary embodiments, the adhesive reducing barrier is applied to at least one region of the first back side of the removable first label proximate the perimeter of the second label, such as in approximately 8 locations (e.g., at each of the four corners of the second label and at least one along the length of the top and bottom edges of the second label when the two labels are attached). In other exemplary embodiments, the adhesive reducing barrier is applied to four regions of the adhesive on the back of the first label corresponding to the four corners of the second label when the two labels are attached. In other exemplary embodiments, the adhesive reducing barrier is applied to four regions of the adhesive on the back of the first label corresponding to the four corners of the second label and to another plurality of regions of the adhesive on the back of the first label corresponding to edges of the second label when the two labels are attached.

In exemplary embodiments, a cohesive force is created between the second front side of the second label and the bin or object to which it is applied. In exemplary embodiments, a cohesive force is created between the second front side of the second label and the first back side of the removable first label. In exemplary embodiments, the second front side of the second label is removably attached to the first back side of the removable first label by static cling force before the removable first label is applied to the bin or object. In exemplary embodiments, the second front side of the second label is removably attached to the first back side of the removable first label by static cling force after the removable first label is removed from the bin or object so that the second label can be removed from the removed removable first label and re-applied to the bin or object. In exemplary embodiments, the second front side of the second label is removably attached to the first back side of the removable first label by static cling force before the removable first label is applied to the bin or object and after the removable first label removed from the bin or object so that the second label can be removed from the removed removable first label and re-applied to the bin or object.

In exemplary embodiments, the area for writing comprises at least 50% of the area of the second front side. In exemplary embodiments, the area for writing comprises a blank area that covers at least 50% of the area of the second front side. In exemplary embodiments, the area for writing comprises some printing that is light enough so as not to obscure writing in black ink with a pen or permanent marker. In exemplary embodiments, the printing comprises an image applied to the second label that is light enough so as not to obscure writing in black ink with a pen or permanent marker on the second front side of the second label. In exemplary embodiments, the printing comprises a pattern applied to the second label that is light enough so as not to obscure writing in black ink with a pen or permanent marker on the second front side of the second label. In exemplary embodiments, the front side of the second label has a composite coating made from recycled materials.

In exemplary embodiments, the area for writing of the second front side can be written on with permanent marker (e.g., SHARPIE brand) and wherein permanent marker writing can be removed from the second front side with a solvent. In exemplary embodiments, the area for writing of the second front side can be written on with permanent marker (e.g., SHARPIE brand) and wherein permanent marker writing can be removed from the second front side with an alcohol-containing solvent, e.g., 70% or higher isopropyl alcohol. In exemplary embodiments, wherein the permanent marker writing can be removed from the second front side with an ethyl alcohol solvent. In exemplary embodiments, the permanent marker writing can be removed from the second front side with solvent including at least one of: ethyl alcohol, isopropyl alcohol, caprylyl glycol, glycerin, isopropyl myristate, tocopheryl acetate, acrylates/C10-30 alkyl acrylate copolymer, aminomethyl Propanol. In exemplary embodiments, the front side of the second label has a dry erase coating. In exemplary embodiments, the removal of the permanent marker writing can be removed with a second object. In exemplary embodiments, the second object is a rag. In exemplary embodiments, the second object is a dry erase eraser.

In exemplary embodiments, the means for attaching the second label to an object comprises a second adhesive on at least part of the second back side. In exemplary embodiments, the means for attaching the second label to an object comprises an electrostatic charge or cohesive force causing the second label to removably stick to a surface of the object wherein the surface is made from any of the following: polyethylene terephthalate, polypropylene, bio-resin, metal, powder-coated metal, wood, glass, or ceramic. In exemplary embodiments, the means for attaching the second label permits the second label to be removed from a surface of the object and repositioned on a surface of the object. In exemplary embodiments, there is no adhesive on the outer corners of the first back side of the removable first label covering a portion of the second label so that when any corner is removed, no adhesive of the first back side lifts up a corresponding corner of the second label underneath. In exemplary embodiments, the removable first label is removable and repositionable. In exemplary embodiments, both the first and second labels are removable and repositionable.

In exemplary embodiments, the first and second adhesives are the same adhesive. In exemplary embodiments, the first and second adhesives are the different and the second adhesive is stronger than the first adhesive. In exemplary embodiments, the second back side of the second label remains attached to the object after removing the removable first label from the object.

In exemplary embodiments, the removable first label further comprises instructions for a user to remove the removable first label from the object or bin (e.g., “peel here” or other instructions to remove the removable first label, printed on the removable first label itself such as on a corner), permitting the user to write on the second label, which is still on the object or bin. In some exemplary embodiments, the object or bin carrying the multi-layer adhering label further comprises instructions for a user to remove the removable first label from the object or bin (e.g., instructions to remove the removable first label on an instruction sheet, retail packaging, or a wrapping), permitting the user to write on the second label, which is still on the object or bin. In some exemplary embodiments, the object or bin carrying the label further comprises instructions for a user to remove the removable first label from the bin and write on the second label, which is still on the bin. In exemplary embodiments, the instructions further comprise instructions for a user to remove and reposition the second label in another location on the bin. In exemplary embodiments, the instructions are on the removable first label. In exemplary embodiments, the instructions are on a sheet of instructions. In exemplary embodiments, the instructions are on retail packaging for the bin. In exemplary embodiments, the instructions are on packaging for the bin. In exemplary embodiments, the instructions are on wrapping for the bin. In exemplary embodiments, the instructions are on retail sales wrapping for the bin.

Various embodiments disclosed herein are directed to a method for making a bin having a multi-layer adhering label affixed thereto, comprising, providing a bin, providing a multi-layer adhering label according to any one of the claims herein having a removable first label and a second label having a second front side and a second back side, and adhering the multi-layer adhering label to a surface of the bin, with the removable first label adhered to the bin and covering at least a portion of the second front side of the second label. Various other embodiments disclosed herein are directed to a method for making a bin having at least a removable first label and a second label, comprising attaching the second label to a surface of the bin, wherein the second label has a second front side and a second back side; and removably adhering the removable first label to the surface of the bin, with the removable first label adhered to the bin and covering at least a portion of the second front side of the second label. In exemplary embodiments, attaching the second label to the surface of the bin comprises applying an electrostatic charge to the second back side so that the second label is removably held to the bin by a cohesive force. In exemplary embodiments, attaching the second label to the surface of the bin comprises applying an electrostatic charge to the second back side so that the second label is removably held to the bin by static cling force. In exemplary embodiments, attaching the second label to the surface of the bin comprises attaching the second label to the bin by cohesion. In exemplary embodiments, attaching the second label to the surface of the bin comprises removably attaching the second label to the bin by cohesion.

Various embodiments disclosed herein are directed to a roll of multi-layer adhering labels, comprising a plurality of multi-layer adhering labels according to any one of the aforementioned embodiments carried by a roll of label liner (a/k/a label backing material).

In exemplary embodiments, the multi-layer adhering label comprises a removable first label having a retail front side and a first back side, wherein the first back side includes a first adhesive on at least part of the first back side, a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side; and wherein the first back side is adhered to, and removable from, the second front side, wherein the first back side covers at least a portion of the second label, the first label carries the second label, and the first label is removable from the second label, and wherein the area for writing of the second front side can be written on with permanent marker (e.g., SHARPIE brand) and wherein permanent marker writing can be removed from the second front side with a solvent. In exemplary embodiments, the multi-layer adhering label, comprises a removable first label having a retail front side and a first back side, wherein the first back side includes a first adhesive on at least part of the first back side, a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side, wherein the first back side is adhered to, and removable from, the second front side, wherein the first back side covers at least a portion of the second label, the first label carries the second label, and the first label is removable from the second label, and wherein the second adhesive permits the second label to be removed from a surface of an object and repositioned on the same surface or another surface of the object.

In exemplary embodiments, the second back side of the second label remains attached to the object after removing the removable first label from the object. In exemplary embodiments, the second adhesive permits the second label to be removed from a surface of an object and repositioned on the same surface or another surface of the object. In exemplary embodiments, the area for writing of the second front side can be written on with permanent marker (e.g., SHARPIE brand), wherein permanent marker writing can be removed from the second front side with a solvent. In exemplary embodiments, the solvent capable of removing the permanent marker from the second front side comprises at least one of: ethyl alcohol, isopropyl alcohol, caprylyl glycol, glycerin, isopropyl myristate, tocopheryl acetate, acrylates/C10-30 alkyl acrylate copolymer, and aminomethyl Propanol. In exemplary embodiments, there is no adhesive, or there is reduced adhesive, neutralized adhesive, or an adhesive reducing barrier, or some other means for reducing adhesion between the first and second labels, on at least a corner of the first back side of the removable first label. In exemplary embodiments, the removable first label comprises point of sale text on its retail front side. In exemplary embodiments, the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label. In exemplary embodiments, the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label. In exemplary embodiments, the 6-12 regions of an adhesive reducing barrier on the first back side of the removable first label are spaced from the outer edge of the first label, and wherein four of the regions are located over a respective corner of the second label and other of the regions are located over one or more edges of the second label when the first label is adhered to the second label.

In exemplary embodiments, the bin having a multi-layer adhering label affixed thereto, the multi-layer adhering label comprises a removable first label having a retail front side and a first back side, wherein the first back side includes a first adhesive on at least part of the first back side to adhere the removable first label to the bin, a second label having a second front side and a second back side, wherein the second front side includes an outer surface capable of being written on with a writing instrument, wherein at least 50% of the second front side provides an area for writing with the writing instrument, and wherein the second label includes means for attaching the second label to the bin on at least part of the back side, wherein the removable first label and the second label are affixed to the bin, with the removable first label at least partially covering the second front side of the second label, and further wherein the first label is removable from the bin and the second label, leaving the second label affixed to the bin, and wherein the area for writing of the second front side can be written on with permanent marker (e.g., SHARPIE brand) and wherein permanent marker writing can be removed from the second front side with a solvent. In exemplary embodiments, the bin having a multi-layer adhering label affixed thereto, the multi-layer adhering label comprises a removable first label having a retail front side and a first back side, wherein the first back side includes a first adhesive on at least part of the first back side to adhere the removable first label to the bin, a second label having a second front side and a second back side, wherein the second front side includes an outer surface capable of being written on with a writing instrument, wherein at least 50% of the second front side provides an area for writing with the writing instrument, and wherein the second label includes means for attaching the second label to the bin on at least part of the back side, wherein the removable first label and the second label are affixed to the bin, with the removable first label at least partially covering the second front side of the second label, and further wherein the first label is removable from the bin and the second label, leaving the second label affixed to the bin, and wherein the means for attaching the second label permits the second label to be removed from a surface of the bin and repositioned on a surface of the bin (the same surface or a different surface of the bin).

In exemplary embodiments, the second back side of the second label remains attached to the bin after removing the removable first label from the bin. In exemplary embodiments, the means for attaching the second label permits the second label to be removed from a surface of the bin and repositioned on a surface of the bin (the same surface or a different surface of the bin). In exemplary embodiments, the area for writing of the second front side can be written on with permanent marker (e.g., SHARPIE brand). In exemplary embodiments, the solvent capable of removing the permanent marker from the second front side comprises at least one of: ethyl alcohol, isopropyl alcohol, caprylyl glycol, glycerin, isopropyl myristate, tocopheryl acetate, acrylates/C10-30 alkyl acrylate copolymer, and aminomethyl Propanol. In exemplary embodiments, there is no adhesive, or there is reduced adhesive, neutralized adhesive, or an adhesive reducing barrier, or some other means for reducing adhesion between the first and second labels, on at least a corner of the first back side of the removable first label. In exemplary embodiments, the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label. In exemplary embodiments, the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label. In exemplary embodiments, the 6-12 regions of an adhesive reducing barrier on the first back side of the removable first label are spaced from the outer edge of the first label, and wherein four of the regions are located over a respective corner of the second label and other of the regions are located over one or more edges of the second label when the first label is adhered to the second label.

Various embodiments are also directed to a kit, comprising an exemplary bin as described herein, and further comprising instructions for a user to remove the removable first label from the bin and write on the second label, which is still on the bin. In exemplary embodiments, the kit comprises a bin having a multi-layer adhering label according to any of the embodiments described herein, and further comprising instructions for a user to remove the removable first label from the bin and write on the second label, which is still on the bin.

In exemplary embodiments, the multi-layer adhering label comprises, a removable first label having a retail front side and a first back side, wherein the first back side includes a first adhesive on the first back side, a second label having a second front side and a second back side, wherein the second front side includes an outer surface capable of being written on with a writing instrument, wherein at least 50% of the second front side comprises an area for writing with the writing instrument, and wherein the second label includes a second adhesive on the second back side, wherein the area for writing of the second front side can be written on with permanent marker (e.g., SHARPIE brand) and wherein permanent marker writing can be removed from the second front side with a solvent, wherein the first back side is adhered to, and removable from, the second front side, wherein the first back side covers the second label and the first label carries the second label, wherein the removable first label further comprises a plurality of regions of an adhesive reducing barrier on the first back side of the removable first label, wherein the plurality of regions are located in a subset of the first adhesive proximate an outer edge of the second label when the first label is adhered to the second label, and wherein the means for attaching the second label permits the second label to be removed from a surface of the object and repositioned on the same or another surface of the object (the same surface or a different surface of the object).

Various embodiments are directed to method for making a bin having a multi-layer adhering label affixed thereto, comprising providing a bin, providing a multi-layer adhering label according to any one of the embodiments disclosed herein, and adhering the multi-layer adhering label to a surface of the bin, with the removable first label adhered to the bin and covering at least a portion of the second front side of the second label.

Various embodiments are directed to a method for preparing a multi-layer adhering label, comprising providing a removable first label having a retail front side and a first back side, wherein the first back side includes a first adhesive on at least a part of the first back side, applying an adhesive reducing barrier to at least one of a region of adhesive on the first back side of the removable first label, providing a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side, and laminating the removable first label and second label together by applying the removable first label overtop the second label, such that the removable first label carries the second label.

Numerous other aspects, advantages, and/or features of the general inventive concepts will become more readily apparent from the following detailed description of exemplary embodiments, from the claims, and from the accompanying drawings being submitted herewith.

### BRIEF DESCRIPTION OF THE DRAWINGS

These and other features of the general inventive concept will become better understood with regard to the following description and accompanying drawings in which:

FIG. 1A depicts an object (here a transparent bin) with an exemplary multi-layer adhering label thereon;

FIG. 1B shows a front/top perspective view of the object with an exemplary multi-layer adhering label thereon;

FIG. 2 depicts the partial removal of a removable first label of an exemplary multi-layer adhering label from an object (here another transparent bin), and a second label having an area for writing with a writing instrument thereunder partially exposed;

FIG. 3 shows the object with the removable first label of FIG. 2 fully removed and the exemplary second label remaining thereon;

FIG. 4 depicts a user marking on an exemplary second label with a writing instrument;

FIGS. 5A-5C depict side-view schematics (everything is in cross section; the cross-hatching represents various means for adhering) of various exemplary multi-layer adhering labels;

FIGS. 6A-6K, 6M, 6Q, 6U, 6W, and 6Y depict rear views of various exemplary removable first labels showing exemplary configurations of the first adhesive on the first back side thereof; FIGS. 6L, 6N, 6O, 6P, 6R-6T, 6V, 6X, and 6Z depict rear views of various exemplary removable first and second labels showing exemplary configurations of the two labels;

FIG. 7 shows a schematic view of an exemplary roll of multi-layer adhering labels;

FIG. 8 shows a side-view schematic of an exemplary second label on an object;

FIGS. 9A-9D depict top-view schematics of various exemplary multi-layer adhering labels (everything is in cross section; the cross-hatching and stippling represent various means for adhering);

FIGS. 10A-10C show various exemplary methods of affixing a multi-layer adhering label to an object;

FIGS. 11A-11C show various exemplary kits comprising an object, a multi-layer adhering label, and instructions to a user for use of the multi-layer adhering label;

FIG. 12A-12B show various exemplary methods of affixing a multi-layer adhering label to an object; and

FIG. 13 shows an exemplary method of preparing a multi-layer adhering label.

### DETAILED DESCRIPTION

With reference to the figures, a multi-layer adhering label comprising a removable first label covering at least a portion of a second label is shown and described herein. This detailed description merely describes exemplary embodiments of the invention and is not intended to limit the scope of the invention in any way. Indeed, the contemplated invention is broader than the exemplary embodiments. The terms used in any future claims have their full ordinary meaning unless an express definition is provided herein.

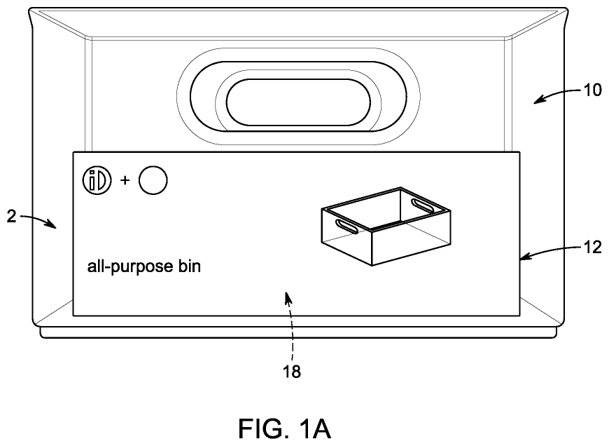

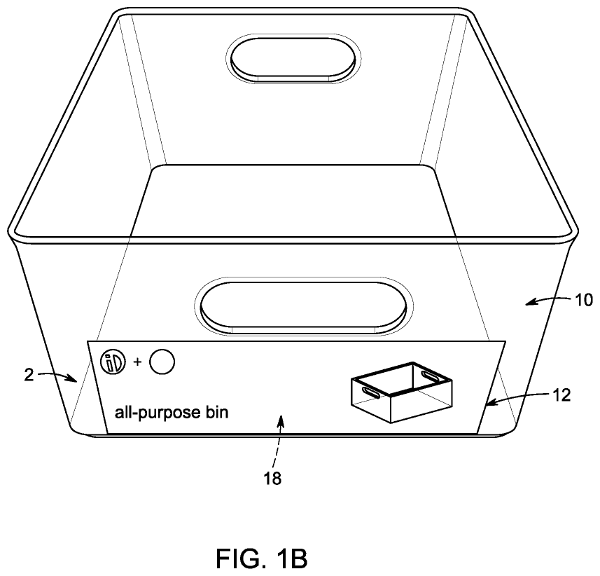

Referring now to FIGS. 1A and 1B, an exemplary multi-layer adhering label 2 is shown. In exemplary embodiments, the multi-layer adhering label 2 is applied to an object 10. The object 10 could be any suitable item, including but not limited to, a bin (e.g., made of transparent and/or opaque and/or translucent plastic, such as PET, or made of wire with a planar plate), some other holder, box, sports gear, food packaging, bottle, jars, shelves, turntables, caddies, dispenser, container, tube, clothing, books, household items, appliances, holders, or furniture, etc. In some exemplary embodiments, the object 10 is a bin. In exemplary embodiments, the object 10 is made of any non-porous material or a porous material. The object 10 can be made from any suitable material, including but not limited to one or more of fiberglass, ceramic, concrete, glass, composite, stone, brick, textile, polymer, synthetic fiber, paper, leather, bio-resin, metal, wood, polyethylene terephthalate, polypropylene, polystyrene, polycarbonate, nylon, or acrylonitrile butadiene styrene. In some embodiments, the object 10 is made of one or more of bio-resin, polyethylene terephthalate, polypropylene, polystyrene, polycarbonate, nylon, or acrylonitrile butadiene styrene. In some exemplary embodiments, any one or more of the object 10 or the multi-layer adhering label 2, or any portion(s) thereof, are completely or partially made of recycled material and/or recyclable material.

In exemplary embodiments, the multi-layer adhering label 2 comprises a removable first label 12 and a second label 18 (behind removable first label 12; not visible in FIGS. 1A and 1B). In exemplary embodiments, the removable first label 12 comprises a retail front side 14 and a first back side 16 (not visible in FIGS. 1A and 1B). In exemplary embodiments, the removable first label 12 is made of any suitable material, including but not limited to, any of, or a combination of, paper, plastic, vinyl, polyester, polyethylene, biaxially-oriented polypropylene, porcelain, whiteboard, melamine, or glass. In some exemplary embodiments, the removable first label 12 is made of 54 #Synthetic paper, e.g., polypropylene with 0.06 mm thickness with an adhesive that permits the removable first label 12 to be removable from the second label 18 and the object 10, e.g., acrylic solvent-based removable adhesive. This material and adhesive are available from Lecco (Kaiping) Adhesive Production Co., Ltd., having an address at No 7-8 Second Industrial District, Cangcheng Town, Kaiping City Jiangmen City, Guangdong, China. In some exemplary embodiments, the removable first label 12 comprises facestock, wherein the material of which the removable first label 12 is formed accepts ink on the retail front side 14 and comprises an adhesive on one or more portions of or the entire the first back side 16. In exemplary embodiments, removable first label 12 is transparent, translucent, and/or opaque, or any one of transparent, translucent, or opaque. In some exemplary embodiments, the removable first label 12 is 0.5-20″ long and 0.5-20″ wide. In still further exemplary embodiments, the removable first label 12 is 2-12″ long and 1-10″ wide. In still further exemplary embodiments, the removable first label 12 is 3-7″ long and 2-5″ wide. In still further exemplary embodiments, the removable first label 12 is about 4-5″ long and 2-3″ wide. In some exemplary embodiments, the removable first label 12 is about 4.5″ long and 2.5″ wide. As shown in FIGS. 1A and 1B (and elsewhere), in exemplary embodiments, the removable first label 12 fully covers the second label 18. In some exemplary embodiments, the removable first label 12 at least partially covers, but does not completely cover, the second label 18.

In exemplary embodiments, the removable first label 12 comprises pre-printed images, markings and/or text on the retail front side 14. “Pre-printing” generally refers to adding images, markings and/or text to the removable first label 12 during or after manufacture and/or formation of the removable first label 12, but before arrival of the removable first label 12 at the point of sale. The pre-printed markings on the removable first label 12 may be in any language, and may comprise a combination of letters, numbers and/or symbols. In exemplary embodiments, pre-printed markings comprise point-of-sale information, for instance, a product description and/or a trademark. In some exemplary embodiments, the removable first label 12 comprises point of sale text indicating one or more of a product description, a trademark, and a product identifier (e.g., a product number and/or a UPC code) and may also comprise a bar code.

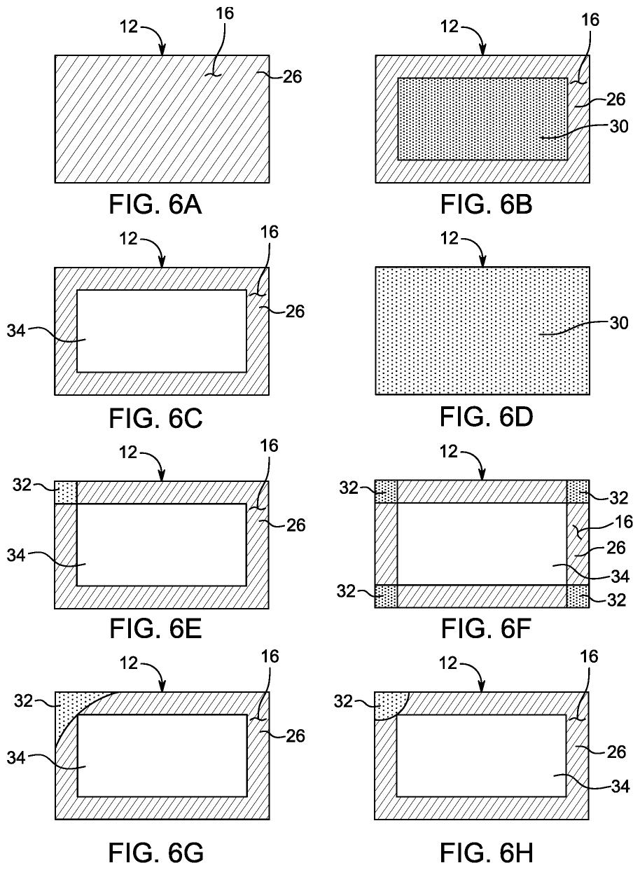

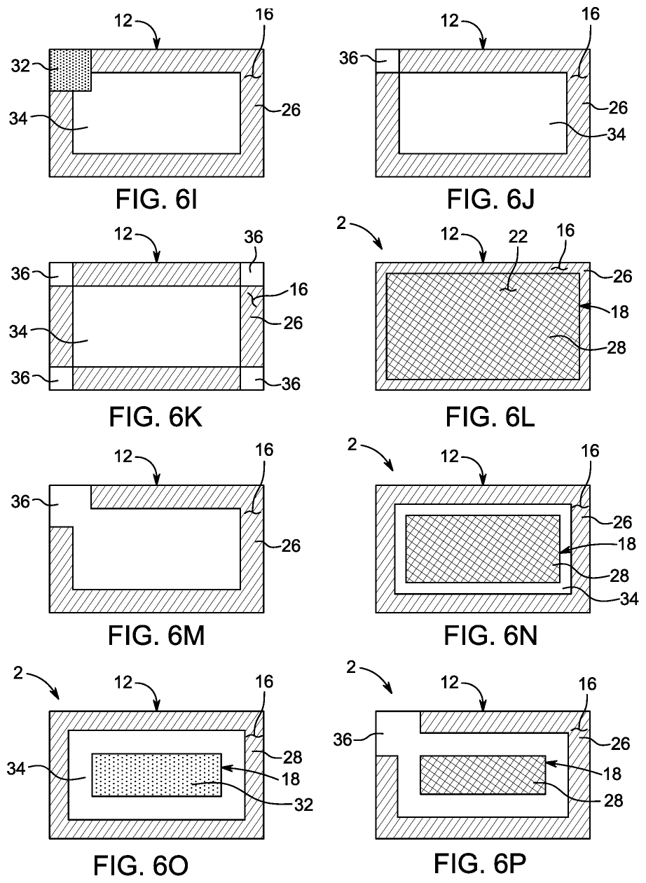

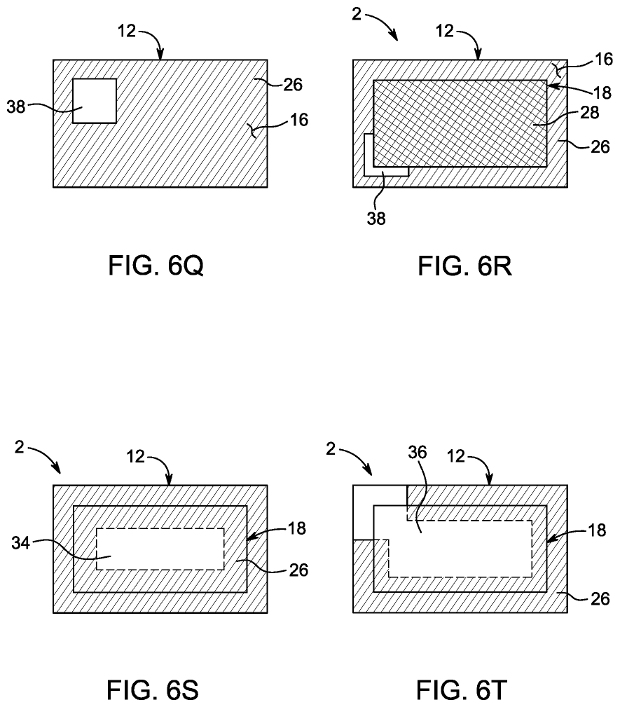

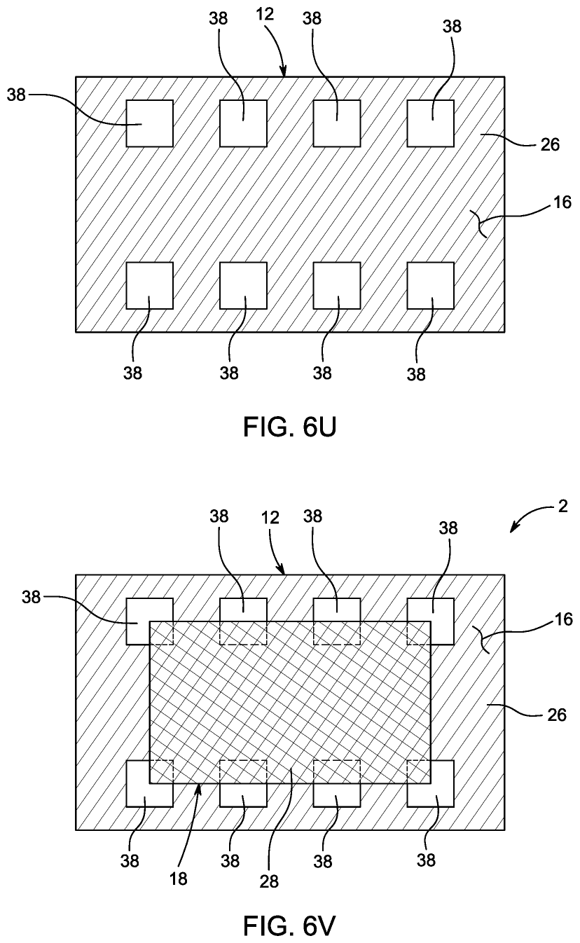

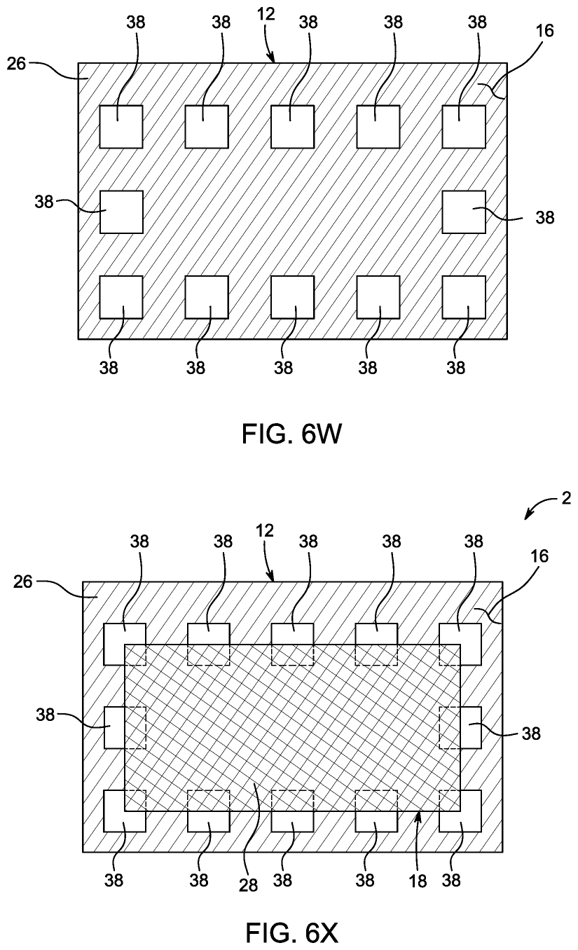

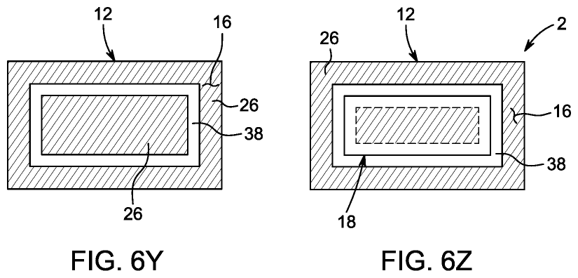

FIG. 2 depicts an exemplary multi-layer adhering label 2 on an object (here a transparent bin), wherein the removable first label 12 is partially peeled away revealing a second label 18 thereunder having an area for writing with a writing instrument. In exemplary embodiments, the removable first label 12 includes a first adhesive 26 on at least part of the first back side 16. The second label 18 has a second front side 20 and a second back side 22 (not visible in FIG. 2). In exemplary embodiments, the area for writing comprises a blank region on the second front side 20. In some exemplary embodiments, the second label 18 has an area for writing that is at least 50% blank, e.g., at least 75% blank or entirely blank. In other exemplary embodiments, the second label 18 has an area for writing with some printing on it that is light enough so as not to obscure writing with a pen or permanent marker, e.g., a lightly printed pattern or image covering at least 50% or covering at least 75% or covering the entire second label 18. In some exemplary embodiments, the area for writing is less than 50% of the area of the second front side 20, e.g., a second label with printing depicting a frame around the area for writing. The second label 18 includes means for attaching the second label 18 to an object 10, such as a bin, on at least part of the second back side 22 of the second label 18. In some exemplary embodiments, the first back side 16 is adhered to, and removable from, the second front side 20. In some other exemplary embodiments, the first back side 16 is adhered to, and removable from, the bin or other object 10 over the second label 18 without being adhered to the second front side 20 of the second label 18 (e.g., FIG. 6N). The first back side 16 covers at least a portion of the second front side 20 of the second label 18. In exemplary embodiments, the removable first label 12 carries the second label 18. In some exemplary embodiments, the removable first label 12 is removable from the object 10 and repositionable on the object 10. In exemplary embodiments, all or part of the first back side 16 of the removable first label 12 is adhered to the second front side 20 by a force that keeps the removable first label 12 attached to the second label 18. In exemplary embodiments, the second back side 22 of the second label 18 remains attached to the object 10 after removing the removable first label 12 from the object 10.

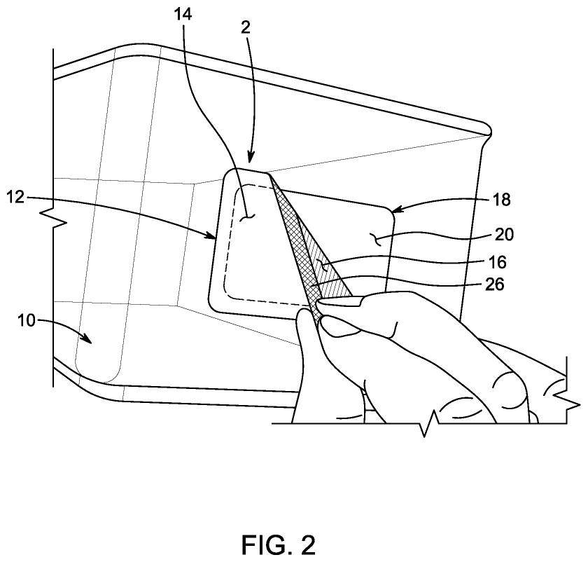

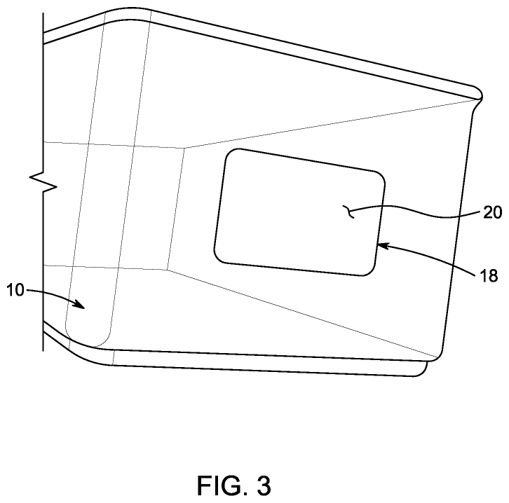

FIG. 3 shows the bin of FIG. 2 with the removable first label 12 of FIG. 2 fully removed and the exemplary second label 18 remaining thereon. The second label 18 could be made out of any suitable material, including but not limited to, any of, or a combination of paper, plastic, vinyl, polyester, polyethylene, biaxially-oriented polypropylene, porcelain, whiteboard, melamine, or glass. In some exemplary embodiments, the second label 18 is made of 54 #Synthetic paper, e.g., polypropylene with 0.06 mm thickness with an adhesive that permits the second label 18 to be removed from the object 10, e.g., acrylic solvent-based removable adhesive, or 50 #clear label paper, e.g., clear polyethylene with 0.05 mm thickness with an adhesive that permits the second label 18 to be removed from the object 10, e.g., acrylic solvent-based removable adhesive. These materials and adhesives are available from Lecco (Kaiping) Adhesive Production Co., Ltd., having an address at No 7-8 Second Industrial District, Cangcheng Town, Kaiping City Jiangmen City, Guangdong, China. In exemplary embodiments, the second label 18 is transparent, translucent, and/or opaque, or any one of transparent, translucent, or opaque. In exemplary embodiments, the second front side 20 of the second label 18 has a composite coating, which in some exemplary embodiments is made from recycled materials. In some exemplary embodiments, the second front side 20 of the second label 18 comprises an additional coating, which in some exemplary embodiments is polypropylene. In some exemplary embodiments, the second label 18 is 0.25-18″ long and 0.25-18″ wide. In still further exemplary embodiments, the second label 18 is 0.5-10″ long and 0.5-8″ wide. In still further exemplary embodiments, the second label 18 is 1-5″ long and 0.75-3″ wide. In still further exemplary embodiments, the second label 18 is about 3-4″ long and 1-2″ wide. In some exemplary embodiments, the second label 18 is about 3.25″ long and 1.25″ wide.

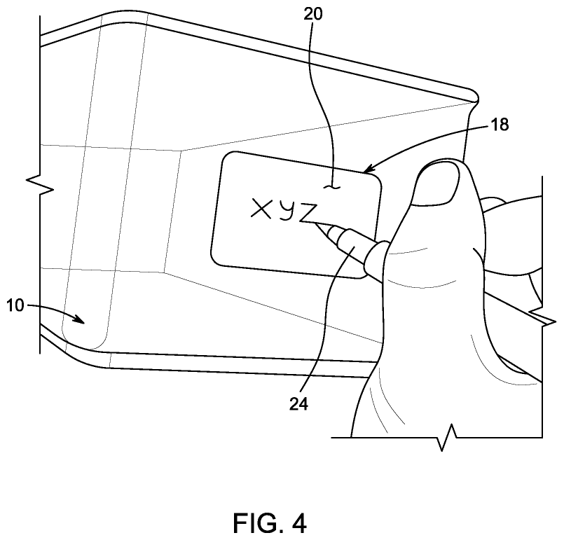

FIG. 4 depicts a user marking on an exemplary second label 18 with a writing instrument 24. The second front side 20 of the second label 18 comprises an area for writing or marking on the second label 18. In exemplary embodiments, the area for writing comprises 25-100% of the area, preferably at least 50% of the area, and more preferably at least 75% of the area, of the second front side 20. In exemplary embodiments, the area for writing with the writing instrument 24 is a completely blank or empty space with no writing, an empty space with markings around it, or a space with markings throughout that are light enough to be written over with a writing instrument 24 (e.g., black ink from a pen or permanent marker), such that said writing is prominently visible and not obscured by the markings thereunder.

For instance, in exemplary embodiments, the area for writing comprises some printing that is light enough so as not to obscure writing in black ink with a pen or permanent marker. In some exemplary embodiments, the printing comprises an image and/or text applied to the second label 18 that is light enough so as not to obscure writing in black ink with a pen or permanent marker on the second front side 20 of the second label 18. In some exemplary embodiments, the second front side 20 of the second label 18 comprises a word, phrase, or list (without an area for writing). The word, phrase, or list could include words such as, but not limited to, groceries, hardware, shopping, crafts, flowers, sports, electronics, clothing, gifts, books, pets, and/or music. In exemplary embodiments, the second front side 20 may include a checklist with empty lines for the user to write on, it could also include a checklist with pre-printed names. For example, the checklist could say “apples, bread, milk, eggs” and the user can check off boxes as they need them from the store, or they could check them off if they are already acquired. In some exemplary embodiments, the second front side 20 comprises a pre-printed mark or marks. The mark may include, but is not limited to, any one of or a combination of, a line, straight line, a curved line, a wavy line, a curly line, dots, dashes, and/or hashes. In some exemplary embodiments, the second label comprises any of the foregoing and also an area for writing with a writing instrument.

In exemplary embodiments, the printing on the second front side 20 of the second label 18 forming the area for writing comprises a color and/or pattern applied to the second label 18 that is light enough so as not to obscure writing in black ink with a pen or permanent marker on the second front side 20 of the second label 18. The pattern could be embedded lightly so the user can easily write on it. The pattern may also be vivid so the user cannot easily see what they write. In some exemplary embodiments, the second front side 20 of the second label 18 further comprises a perimeter or boarder pre-printed thereon, e.g., a printed border around a central area for writing with a writing instrument. Color includes, but is not limited to, any one of or a combination of white, black, red, yellow, orange, green, violet, or any other way to describe the aspect in terms of hue, lightness, and saturation. The second front side 20 could also have pre-printed 3D letters or markings. For non-limiting example, it could be pre-printed with braille or embossed or etched with markings, text, or symbols.

In exemplary embodiments, the second front side 20 of the second label 18 can be written on or marked with any suitable writing or marking device, including but not limited to, marks made by any writing instrument, such as pens, pencils, crayons, markers (permanent (e.g., SHARPIE brand), dry erase, and non-permanent, etc.), paint, ink, chalk, or the like. In some exemplary embodiments, the second front side 20 of the second label 18 can be marked with scratches, etches, indentations, and the like. In exemplary embodiments, the writing made by the user on the second label 18 can be removed. In exemplary embodiments, the area for writing of the second front side 20 can be written on with permanent marker (e.g., SHARPIE brand), and in some embodiments, the permanent marker writing can be removed from the second front side 20 with a solvent. The solvent may be any solvent known to remove the writing in question. For example, SHARPIE brand permanent ink can be removed with various solvents (even after a 24 hour cure time at room temperature), including but not limited to, (a) PURELL brand hand sanitizer: ethyl alcohol, isopropyl alcohol, caprylyl glycol, glycerin, isopropyl myristate, tocopheryl acetate, acrylates/C10-30 alkyl acrylate copolymer, aminomethyl propanol, and (b) other alcohol-containing solvents, e.g., so-called “rubbing alcohol,” 70% or higher isopropyl alcohol, or an ethyl alcohol solvent, and (c) other solvents such as acetone or acetone-based fingernail polish remover. In particular, second labels made from (or having an outward facing first surface made of) 54 #Synthetic paper, e.g., polypropylene with 0.06 mm thickness, or 50 #clear polyethylene with 0.05 mm thickness can accept SHARPIE brand permanent ink that is removable with alcohol-based hand sanitizer. In other exemplary embodiments, the writing with some writing instruments (e.g., a grease pencil and/or so-called dry erase markers) can be removed with a second object, including but not limited to a rag, user's hand, or finger, and/or eraser.

In some exemplary embodiments, the second front side 20 of the second label 18 has a dry erase coating. The second front side 20 could additionally be a dry-erase film, made by an epoxy additive that dries to an erasable surface, such that the user may write on the second front side 20 with a dry erase marker or wet erase marker and erase it later. The writing might be able to erase with a rag or a finger, but it may also be erased with water or any solution mentioned herein.

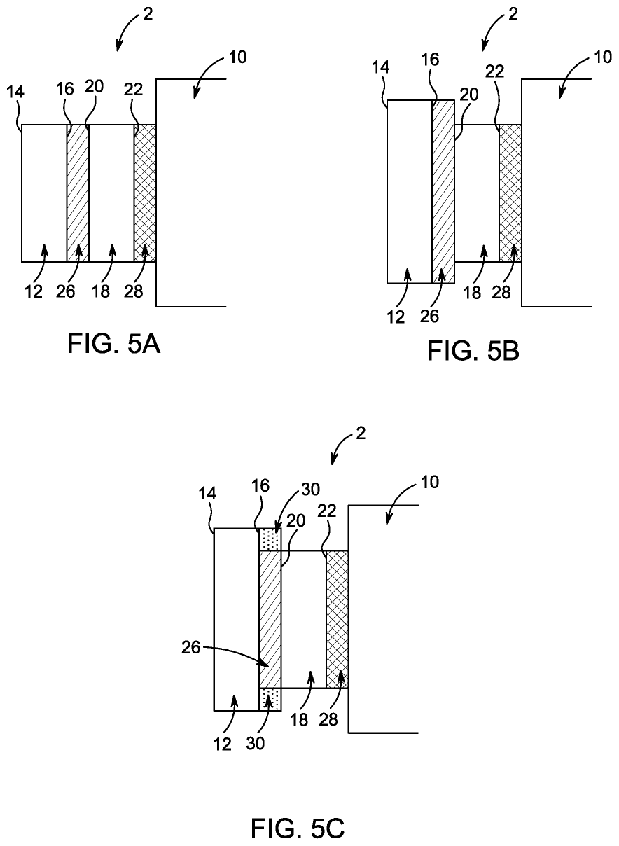

FIGS. 5A-5C depict side-view schematic cross sectional views of various exemplary multi-layer adhering labels 2 (all of the materials are in cross section, the cross hatching shows adhesives and other means for attaching), each comprising a removable first label 12, having a retail front side 14 and a first back side 16, a first adhesive 26 in contact with the first back side 16 and a second front side 20 of a second label 18, wherein the second label 18 has a second back side 22 which is in contact with a second adhesive 28, and wherein the second adhesive is proximate an object 10, such as a bin. Suitable adhesives for the first adhesive 26 include acrylic solvent-based removable adhesives and other adhesives that permit the removable first label 12 to be removed from the second label 18 and the object 10. Suitable adhesives for the second adhesive 28 include acrylic solvent-based removable adhesives and other adhesives that permit the second label 18 to be removed from the object 10. As shown in FIG. 5A, at least one of the width or height of the removable first label 12 and the second label 18 may be substantially the same. In some embodiments, the dimensions of the removable first label 12 and the second label 18 are substantially the same, such that the removable first label 12 fully covers the second label 18. As shown in FIG. 5B, in some embodiments, at least one of the width or height of the removable first label 12 may be greater than the respective width or height of the second label 18. In some embodiments, the dimensions of the removable first label 12 are greater than that of the second label 18, such that the removable first label 12 fully covers the second label 18 and a portion of the first adhesive 26 extends beyond the edge of the second label 18. As shown in FIG. 5C, in some embodiments, at least one of the width or height of the removable first label 12 may be greater than the respective width or height of the second label 18, wherein the removable first label 12 further comprises a third adhesive 30 proximate to a portion of the first back side 16 of the removable first label 12, and preferably, on the portion of the first back side 16 that extends beyond the edge of the second label 18. In exemplary embodiments, the third adhesive 30 may also comprise a region of no adhesive, neutralized adhesive, and/or an adhesive reducing barrier. In exemplary embodiments, the first adhesive 26 of the removable first label 12 is removably adhered to at least 10% of the area of the second label 18 second front side 20. In exemplary embodiments, the entire second label 18 second front side 20 is adhered to, and removable from, the first adhesive 26 of the removable first label 12. In exemplary embodiments, the entire second label 18 second front side 20 is adhered to, and removable from, the first adhesive 26 of the removable first label 12, except for at least one region of no adhesive, neutralized adhesive, and/or an adhesive reducing barrier (as shown in FIGS. 6C-6Z) on at least one of the first back side 16 and/or the second front side 20.

FIGS. 6A-6K, 6M, 6Q, 6U, 6W, and 6Y depict rear views of various exemplary removable first labels 12 showing exemplary configurations of the first adhesive 26 on the first back side 16 thereof. FIGS. 6L, 6N, 6O, 6P, 6R-6T, 6V, 6X, and 6Z depict rear views of various exemplary removable first and second labels 12, 18 showing exemplary configurations of the two labels. One way to think of FIGS. 6L, 6N, 6O, 6P, 6R-6T, 6V, 6X, and 6Z is a view of the two labels looking through the rear of a transparent wall of a bin to which the two labels are attached. As shown in FIG. 6A, in some embodiments the first adhesive 26 covers substantially all the first back side 16. As shown in FIG. 6B and 6C, in exemplary embodiments, the first adhesive 26 is on only a perimeter of the first back side 16, or a portion of the perimeter of the first back side 16 (e.g., only on upper and lower edges or only on left and right edges, not shown), wherein at least a central region 34 of the first back side 16 is without adhesive (e.g., FIG. 6C) or may optionally comprise a third adhesive 30 (e.g., FIG. 6B). In exemplary embodiments, the third adhesive 30 may also comprise a region of no adhesive, neutralized adhesive, and/or an adhesive reducing barrier. In exemplary embodiments, the first adhesive 26 is on only a perimeter of the first back side 16, or a portion of the perimeter of the first back side 16 (e.g., only on upper and lower edges or only on left and right edges, only on the left and right sides, or only in the corners, not shown), leaving at least a central region 34 of the first back side 16 at least as large as the second label 18 without adhesive so that the removable first label 12 can cover the second front side 20 of the second label 18 without adhering thereto (FIG. 6N). As shown in FIGS. 6D-6I, the first back side 16 may include at least a portion of a third adhesive 30 and/or a fourth adhesive 32, wherein the third adhesive 30 and/or fourth adhesive 32 may be present in any one or more of the center of the first back side 16, or at least one of the corners of the first back side 16, or the entirety of the first back side. The configuration of the third adhesive 30 and/or fourth adhesive 32 may be of any shape, including but not limited to a rectangle, square, or a radial corner. The third adhesive 30 and/or fourth adhesive 32 comprises of any acceptable adhesive material, and may include static cling, as described further below. In exemplary embodiments, the third adhesive 30 and/or fourth adhesive 32 may also comprise a region of no adhesive, neutralized adhesive, and/or an adhesive reducing barrier. In exemplary embodiments, there is adhesive only on the outer corners of the first back side 16 of the removable first label 12. In exemplary embodiments, there is no adhesive on at least one of the corner regions 36 of the first back side 16 of the removable first label 12 covering a portion of the second label 18 so that when that corner is removed, no adhesive of the first back side 16 lifts up a corresponding corner of the second label 18 underneath (e.g., 36 in FIGS. 6J, 6K, and 6M). FIGS. 6C, 6E-6P, 6S, and 6T show exemplary removable first labels 12 with no adhesive in a central region 34, i.e., adhesive only around some or all of the perimeter. In FIGS. 6M, 6P, and 6T, there is a corner region 36 with no adhesive in the corner nor on part of the perimeter adjacent to that corner (as well as no adhesive in the central region 34 of the removable first label 12). FIG. 6Q shows an exemplary removable first label 12 with adhesive around the perimeter and in a central region except for one small region 38 adjacent one corner that is intended to be located over a corresponding corner of the second label (FIG. 6R). In exemplary embodiments, the small region with no adhesive comprises 5-25% or 10-15% of the area of the back of the removable first label 12. In some exemplary embodiments, the first front side 14 of the removable first label 12 of FIG. 6Q comprises text reading “peel here” or the like to indicate to the user the location of the one corner that can be peeled without lifting the corresponding corner of the second label (e.g., FIG. 6R). FIGS. 6U, 6W, and 6Y depict the first back side 16 of exemplary removable first labels 12 comprising at least one small region 38 with no adhesive (or an adhesive reducing barrier, as explained herein) proximate the interface between the edge of the second label 18 and the first back side 16 of the removable first label 12. In exemplary embodiments, the first back side 16 comprises 1-50 small regions 38, or 5-25 small regions 38, and sometimes approximately 5-10 small regions 38. In some exemplary embodiments the 5-10 small regions 38 are proximate each of the four corners of the second label 18 and at least one additional region along the length of the top and/or bottom edges of the second label 18), e.g., FIGS. 6U and 6W. In some exemplary embodiments, as shown in 6Y, the small region 38 with no adhesive (or an adhesive reducing barrier, as explained herein) comprises a perimeter area that corresponds to the edge of the second label 18, such that edge of the second label 18 is positioned within the small region 38 of no adhesive (or an adhesive reducing barrier, as explained herein) when the second label 18 is proximate the removable first label 12. Alternate embodiments (not shown) comprise a relatively small region 38 without adhesive (or an adhesive reducing barrier, as explained herein) over two or three corners of the second label 18.

FIGS. 6L, 6N, 6O, 6P, 6R-6T, 6V, 6X, and 6Z show exemplary multi-layer adhering labels 2 formed with one of the removable first labels 12 of the foregoing figures and a second label 18 with second adhesive 28. FIG. 6L shows an exemplary multi-layer adhering label 2 formed with a removable first label 12 of FIG. 6A behind and adhered to a slightly smaller second label 18 having second adhesive 28 all over its back. FIG. 6N shows an exemplary multi-layer adhering label 2 formed with a removable first label 12 of FIG. 6C behind a much smaller second label 18 having second adhesive 28 all over its back so that the second label 18 does not adhere to the first adhesive 26. FIG. 6O shows an exemplary multi-layer adhering label 2 formed with a removable first label 12 of FIG. 6C behind a much smaller second label 18 having a third adhesive 30 (e.g., static cling) all over its back so that the second label 18 does not adhere to the first adhesive 26. FIG. 6P shows an exemplary multi-layer adhering label 2 formed with a removable first label 12 of FIG. 6M behind a smaller second label 18, with a corner of the second label 18 proximate the corner region 36 of the removable first label 12 without adhesive. FIG. 6R shows an exemplary multi-layer adhering label 2 formed with a removable first label 12 of FIG. 6Q behind and adhered to a slightly smaller second label 18 having second adhesive 28 all over its back, with a corner of the second label 18 over the small region 38 of the removable first label 12 without adhesive. Alternate embodiments (not shown) comprise a relatively small region 38 without adhesive over two, over three, or all four corners of the second label 18. FIG. 6S shows an exemplary multi-layer adhering label 2 formed with a removable first label 12 of FIG. 6C behind and adhered to a slightly smaller second label 18. FIG. 6T shows an exemplary multi-layer adhering label 2 formed with a removable first label 12 of FIG. 6M behind and adhered to a slightly smaller second label 18, with a corner of the second label 18 proximate the corner region 36 of the removable first label 12 without adhesive. In some exemplary embodiments, the first front side 16 of the removable first label 12 of FIGS. 6R or 6T comprises text reading “peel here” or the like to indicate to the user the location of the corner that can be peeled without lifting the corresponding corner of the second label 18. FIGS. 6V, 6X, and 6Z depict the first back side 16 of exemplary removable first labels 12 comprising at least one small region 38 with no adhesive (or an adhesive reducing barrier, as explained herein) proximate the interface between the edge of the second label 18 and the first back side 16 of the removable first label 12 (as shown in FIGS. 6U, 6W, and 6Y), further depicting the second label 18 adhered to the first back side 16 of the removable first label 12. In some exemplary embodiments, the small region or regions 38 with no adhesive (or an adhesive reducing barrier, as explained herein) comprise(s) a perimeter area that corresponds to the edge of the second label 18, such that edge of the second label 18 is positioned within the small region or regions 38 of no adhesive when the second label 18 is proximate the removable first label 12.

As described further herein, it is understood that the regions described herein as being “without adhesive” or having a “third adhesive” or “fourth adhesive” e.g., 30, 32, 34, 36, 38, shall also include regions where adhesive is or was present, but where said adhesive has been neutralized or reduced, such as where said region further comprises an adhesive reducing barrier, e.g., silicone oil or varnish, applied on top of said existing adhesive, wherein said adhesive reducing barrier counteracts, reduces, or neutralizes the adhesive, and the prevents said regions (e.g., 30, 32, 34, 36, 38) from adhering to the second front side 20 of the second label 18 (effectively resulting in an area without adhesive properties, or at least reduced adhesive properties so that the first label can be removed without lifting any of the second label). It is also understood that any or all of said regions, e.g., 30, 32, 34, 36, 38 described herein as being on the first back side 16 of the removable first label 12, may instead, or in addition, be present on the second front side 20 of the second label 18, e.g., by spraying or printing an adhesive reducing barrier on the front of the second label.

In some exemplary embodiments, a first adhesive 26 is applied to the first back side 16 of removable first label 12 and an adhesive reducing barrier is applied to the first back side 16 over a subset of the adhesive to create a region of the removable first label with a barrier between the adhesive and the second label 18 to create a region of the removable first label 12 that effectively has no adhesive (even though it does). For an example, in some exemplary embodiments, a first adhesive 26 is applied uniformly all over the first back side 16 of the removable first label 12 (like FIG. 6A) and then an adhesive reducing barrier is applied to a smaller region of the back, such as regions 34, 36, 38 or any of the other regions shown or described without adhesive. In some exemplary embodiments, the adhesive reducing barrier is a very thin layer of silicone oil applied as to a region of the back, such as regions 34, 36, 38 or any of the other regions without adhesive, e.g., printed onto the first adhesive 26 like ink would be printed. Exemplary embodiments with an adhesive reducing barrier applied permit the removable first label 12 to be removed more easily from the second label by putting a barrier between the first adhesive 26 and the second label 18. In the alternative, the region or adhesive reducing barrier is printed on the front of the second label 18 instead of or in addition to a region or adhesive reducing barrier applied to the first back side 16 of the removable first label 12. In exemplary embodiments, the adhesive reducing barrier is applied to at least one region of the first back side 16 of the removable first label 12 corresponding with the perimeter or outer edge of the second label 18 (when the second label 18 is proximate to the removable first label 12). In exemplary embodiments, the adhesive reducing barrier is applied in 1-50 regions, 5-2 regions, or 5-10 regions (e.g., proximate each of the four corners of the second label 18 and in at least one region along the length of the top and bottom edges of the second label 18), e.g., see FIGS. 6U-6Z. In some exemplary embodiments, as shown in 6Y and 6Z, the small region 38 with no adhesive comprises a perimeter area that corresponds to the edge of the second label 18, such that edge of the second label 18 is positioned within the region of no adhesive 38 when the second label 18 is proximate the removable first label 12. In some embodiments, the adhesive reducing barrier may be silicone oil, such as Polydimethylsiloxane (C₂H₆OSi)ₙ. In exemplary embodiments, the silicone oil is applied as a varnish. In exemplary embodiments, the silicone oil varnish has a matte finish. In exemplary embodiments, the silicone oil is any one or more of low odor, wear-resistant, high-gloss and high-transparency. In exemplary embodiments, the adhesive reducing barrier comprises silicone oil in the form of flexo printing ink. In exemplary embodiments, the region without adhesive may comprise any pattern or shape. It is fully understood that any of the adhesive patterns shown and described in one or more of FIGS. 6A-6Z may be present alone or in combination with any one or more of the adhesive patterns shown in any other of FIGS. 6A-6Z. As a non-limiting example thereof, the adhesive pattern on the first back side 16 of the removable first label 12 may comprise the regions without adhesive shown in FIGS. 6U-6Z in combination with the region of no adhesive proximate the corner of the removable first label 12, as shown in FIG. 6M, 6P, and/or 6Q-6R.

In exemplary embodiments, a cohesive force is created between the second front side 20 of the second label 18 and the bin or object 10 to which it is applied. In exemplary embodiments, a cohesive force is created between the second front side 20 of the second label 18 and the first back side 16 of the removable first label 12. In exemplary embodiments, the second front side 20 of the second label 18 is removably attached to the first back side 16 of the removable first label 12 by static cling force before the removable first label 12 is applied to the bin or object 10. The static cling material can include vinyl, polyvinyl chloride (PVC), BOPP, PET or any other polymer film having a static cling surface. The static cling film can affix to the second front side 20 using cohesive forces between the first back side 16 and the second front side 20. The cohesive forces are intermolecular forces of attraction which act between the molecules of the same substance. The static-cling film is adhered to the first back side 16. The second front side 20 is receiving the static-cling film and is adhered to by electrostatic properties of the film. In exemplary embodiments, the second front side 20 of the second label 18 is removably attached to the first back side 16 of the removable first label 12 by static cling force after the removable first label 12 is removed from the object 10 so that the second label 18 can be removed from the removable first label 12 and re-applied to the object 10. In exemplary embodiments, the second front side 20 of the second label 18 is removably attached to the first back side 16 of the removable first label 12 by static cling force before the removable first label 12 is applied to the bin or object 10 and after the removable first label 12 removed from the bin or object 10 so that the second label 18 can be removed from the removable first label 12 and re-applied to the bin or object 10.

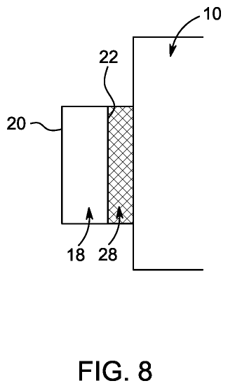

FIG. 8 shows a side-view schematic cross sectional view of an exemplary second label 18 on an object 10 (all of the materials are in cross section, the cross hatching and stippling show adhesives and other means for attaching), wherein the second label 18 comprises a second front side 20 and a second back side 22, wherein the second back side 22 is at least partially covered by a second adhesive 28, and wherein the second adhesive 28 is affixed to an object 10. In exemplary embodiments, the means for attaching the second label 18 to the object 10 permits the second label 18 to be removed from a surface of the object 10 and repositioned on the same or another surface of the object 10 (the same surface or a different surface of the object 10). In exemplary embodiments, the means for attaching the second label 18 to an object 10 comprises a second adhesive 28 on at least part of the second back side 22. In exemplary embodiments, the means for attaching the second label 18 to an object 10 comprises an electrostatic charge or cohesive force causing the second label 18 to removably stick to a surface of the object 10 wherein the surface is made from any of the following: polyethylene terephthalate, polypropylene, bio-resin, metal, powder-coated metal, wood, glass, or ceramic. In exemplary embodiments, the means for attaching the second label 18 permits the second label 18 to be removed from a surface of the object 10 and repositioned on a surface of the object 10. In exemplary embodiments, both the removable first and second label 12,18 are removable and repositionable.

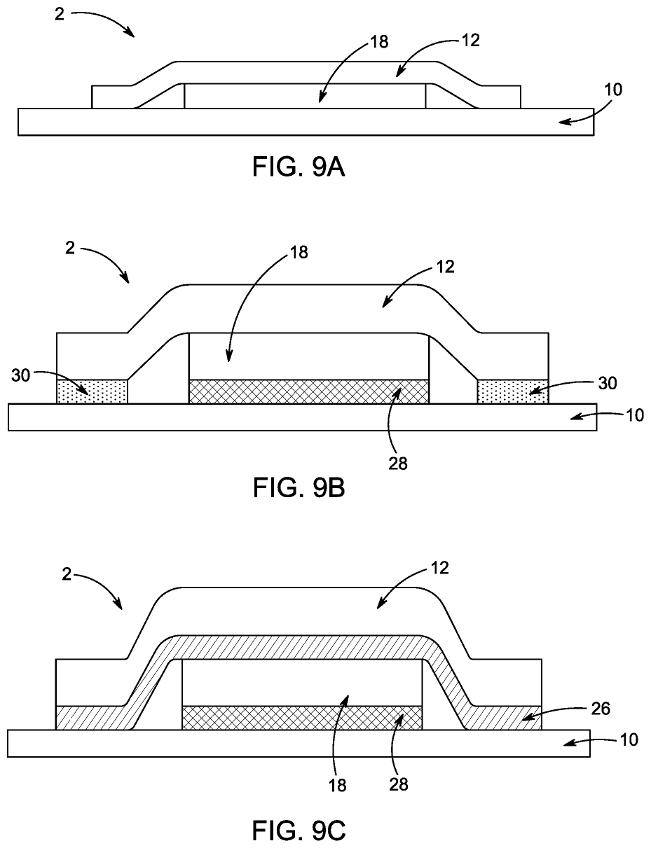

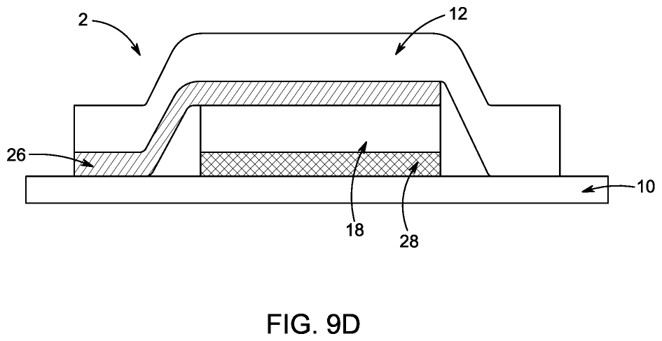

FIGS. 9A-9D depict side-view schematic cross-sectional views of various exemplary multi-layer adhering labels 2 (all of the materials are in cross section, the cross hatching and stippling show adhesives and other means for attaching). In exemplary embodiments, the first adhesive 26 and second adhesive 28 are the same adhesive. In exemplary embodiments, the first adhesive 26 and second adhesive 28 are different and the second adhesive 28 is stronger than the first adhesive 26. FIG. 9A illustrates an exemplary multi-layer adhering label 2 comprising a removable first label 12 and a second label 18, wherein the removable first label 12 is greater in size than the second label 18 and extends beyond the edges of the second label 18. FIG. 9B illustrates an exemplary multi-layer adhering label 2 comprising a removable first label 12 comprising an adhesive, such as a first adhesive 26 (not shown) or a third adhesive 30 (shown), present on a portion of the removable first label 12, such as the outer edges thereof, and a second label 18 comprising a second adhesive 28, wherein the removable first label 12 is greater in size than the second label 18 and extends beyond the edges of the second label 18, and wherein the portion of the removable first label 12 comprising the adhesive layer, e.g., the third adhesive 30, does not contact the second label 18, but rather extends beyond the edges of the second label 18 to affix to an object 10, at least partially encapsulating the second label 18 underneath the removable first label 12. FIG. 9C illustrates an exemplary multi-layer adhering label 2 comprising a removable first label 12 comprising an adhesive, such as a first adhesive 26, present on a portion of the removable first label 12, and preferably the entire first back side 16 thereof, and a second label 18 comprising a second adhesive 28, wherein the removable first label 12 is greater in size than the second label 18 and extends beyond the edges of the second label 18, and wherein a portion of the adhesive layer, e.g., the first adhesive 26, extends beyond the edges of the second label 18 to affix to an object 10, at least partially encapsulating the second label 18 underneath the removable first label 12. FIG. 9D illustrates an exemplary multi-layer adhering label 2 comprising a removable first label 12 comprising an adhesive, such as a first adhesive 26, present on at least a portion of the removable first label 12, and a second label 18 comprising a second adhesive 28, wherein the removable first label 12 is greater in size than the second label 18 and extends beyond the edges of the second label 18, and wherein a portion of the adhesive layer, e.g., the first adhesive 26, extends beyond the edges of the second label 18 to affix to an object 10, at least partially encapsulating the second label 18 underneath the removable first label 12, and wherein a portion of the first back side 16 of the removable first label 12 does not contain an adhesive, such that a user might peel back the removable first label 12 by pulling back on the portion of the removable first label 12 that does not contain an adhesive.

In exemplary embodiments, the multi-layer adhering label 2 further includes a plurality of additional labels, e.g., at least a third label (not shown) (or perhaps even sequentially stacked fourth, fifth, and sixth, etc. labels) slightly smaller than and under the second label 18, to allow the user to keep making labels by removing the topmost label to reveal a blank label thereunder. In some exemplary embodiments, there is at least a third label with a third front side and a third back side, where the third front side is attached to the second back side and the third back side is attached to the object 10. At least a portion of the second back side 22 may have means for adhesion thereon. There may be at least one corner without adhesion, allowing for a user to peel it back to reveal another label.

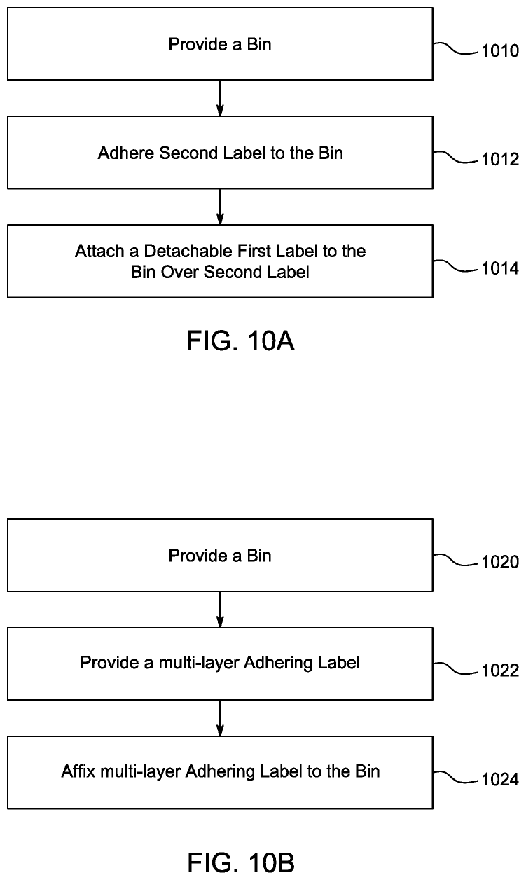

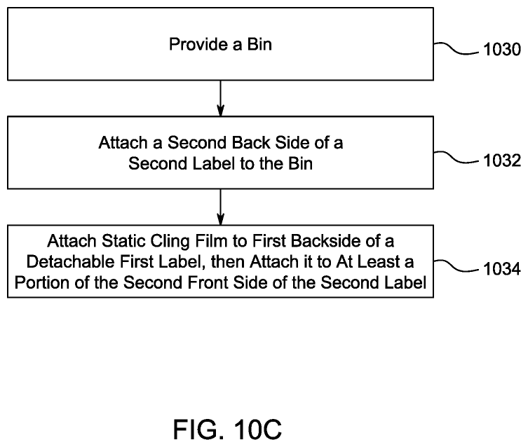

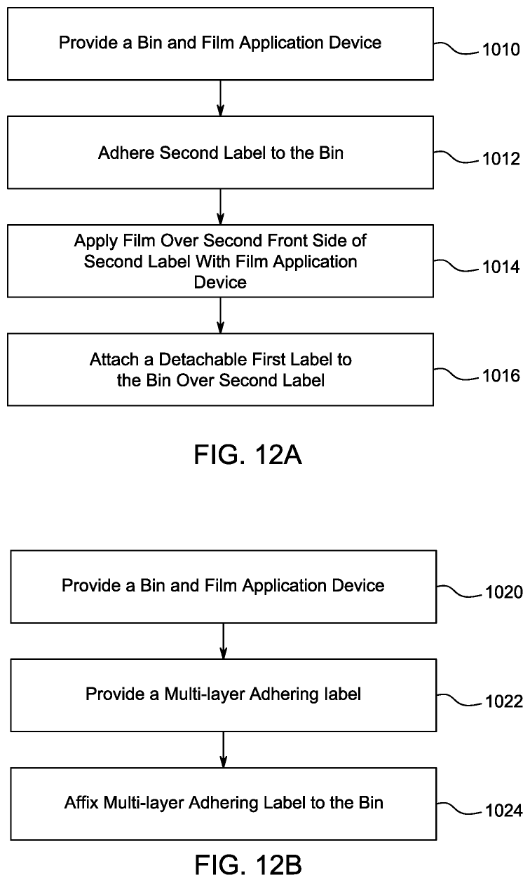

FIGS. 10A-10C and 12A-12B show various exemplary methods of affixing a multi-layer adhering label 2 to an object 10. FIG. 10A illustrates a method of affixing a multi-layer adhering label 2 to an object 10, including providing an object 10, such as a bin (step 1010), adhering a second label 18 to the object 10 (step 1012), and attaching a detachable or removable first label 12 to the object 10 over the second label 18 (step 1014). FIG. 10B illustrates a method of affixing a multi-layer adhering label 2 to an object 10, including providing an object 10, such as a bin (step 1020), providing a multi-layer adhering label according to any of the embodiments described above (1022), and affixing said multi-layer adhering label to the object 10 (1024). FIG. 10C illustrates a method of affixing a multi-layer adhering label 2 to an object 10, including providing an object 10, such as a bin (step 1030), attaching a second back side 22 of a second label 18 to an object 10 (1032), and attaching static cling film to first back side 16 of a removable first label 12, then attaching it to at least a portion of the second front side 20 of the second label 18 (1034). FIG. 12A illustrates a method of affixing a multi-layer adhering label 2 to an object 10, including providing an object 10, such as a bin, and a film application device (step 1010), adhering the second label 18 to the object 10 (1012), applying film over a second front side 20 of the second label 18 with the film application device (1014), and attach a removable first label 12 to the object over a second label 18 (step 1016). FIG. 12B illustrates a method of affixing a multi-layer adhering label 2 to an object 10, including providing an object 10, such as a bin, and a film application device (step 1020), provide a multi-layer adhering label 2 (1022), and affix the multi-layer adhering label 2 to the object 10 (step 1024). In exemplary embodiments, the removable first label 12 adhered to the object 10 covers at least a portion of the second front side 20 of the second label 18. In exemplary embodiments, the method for making an object, such as a bin, having at least a removable first label 12 and a second label 18, comprises attaching the second label 18 to a surface of the object, wherein the second label 18 has a second front side 20 and a second back side, and removably adhering the removable first label 12 to the surface of the object, with the removable first label 12 adhered to the object and covering at least a portion of the second front side 20 of the second label 18. In exemplary embodiments, attaching the second label 18 to the surface of the object comprises applying an electrostatic charge to the second back side 22 so that the second label 18 is removably held to the object 10 by a cohesive force. In exemplary embodiments, attaching the second label 18 to the surface of the object 10 comprises applying an electrostatic charge to the second back side 22 so that the second label 18 is removably held to the object 10 by static cling force. In exemplary embodiments, attaching the second label 18 to the surface of the object 10 comprises attaching the second label 18 to the object 10 by cohesion. In exemplary embodiments, attaching the second label 18 to the surface of the object 10 comprises removably attaching the second label 18 to the object 10 by cohesion.

In exemplary embodiments, the removable first label 12 further comprises instructions for a user to remove the removable first label 12 from the object or bin 10 (e.g., “peel here” or other instructions to remove the printed on the removable first label itself such as on a corner), permitting the user to write on the second label 18, which is still on the object or bin 10. In some exemplary embodiments, the “peel here” or other instructions on the retail front side 14 of the removable first label 12 corresponds to a region of no adhesive, less adhesive, or weaker adhesive on the first back side 16 of the removable first label 12. In some exemplary embodiments, the removable first label 12 or the object or bin 10 carrying the multi-layer adhering label 2 further comprises instructions for a user to remove the removable first label 12 from the object or bin 10 (e.g., “instructions to remove the removable first label on an instruction sheet, retail packaging, or a wrapping), permitting the user to write on the second label 18, which is still on the object or bin 10. In some exemplary embodiments, the removable first label 12 or object or bin 10 carrying the multi-layer adhering label 2 comprises instructions for a user to remove the removable first label 12 from the object or bin 10 (e.g., “instructions to remove the removable first label on an instruction sheet, retail packaging, or a wrapping), and further instructions for the user to write on the second label 18, which is still on the object or bin 10. In exemplary embodiments, the removable first label 12 also includes a statement that there is a label with a writing area underneath, e.g., a blank label or any of the various writing areas described herein.

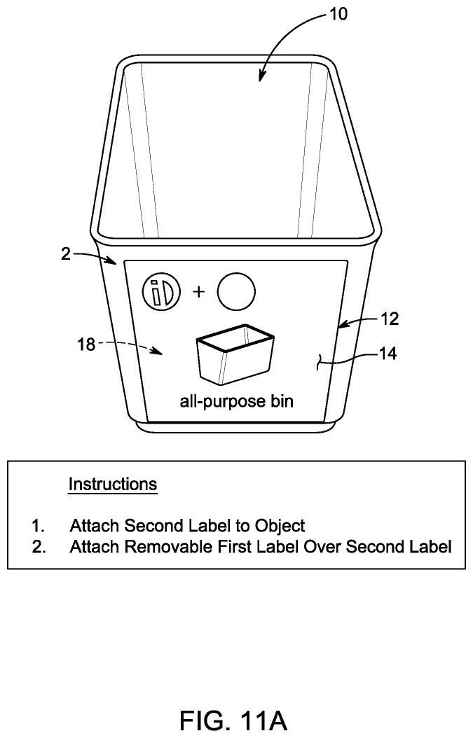

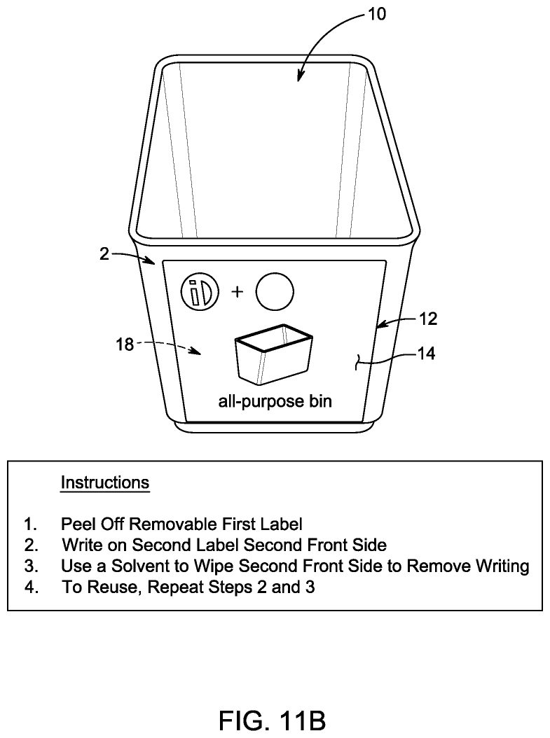

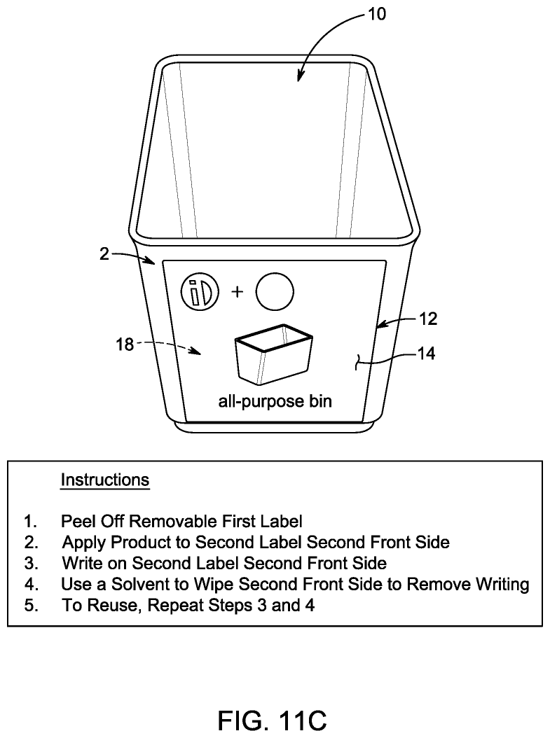

FIGS. 11A-11C show various exemplary kits comprising an object such as a bin, a multi-layer adhering label 2, and instructions to a user describing how to use the multi-layer adhering label 2. In exemplary embodiments, the instructions include a description for a user to remove the removable first label 12 from an object 10 such as a bin (e.g., as simple as “peel here” in a corner of the removable first label 12 or more elaborate instructions) and write on the second label 18, which may still be affixed to the object 10. In exemplary embodiments, the instructions further comprise instructions for a user to remove and reposition the second label 18 (and/or the removable first label 12) in another location on the object 10. The instructions may be on any one or more of the removable first label 12 (e.g., “peel here” or the like), on a separate sheet of instructions, on the retail packaging for the object 10, and/or on the wrapping for the object 10. In some exemplary embodiments, the instructions are on retail sales wrapping for the object 10. In another embodiment, the multi-layer adhering label 2 kit may include an applicator. After the user removes the removable first label 12, they can use the applicator to apply a film to the second label 18, allowing it to be written on and then removed with a rag or solvent. This way, instead of the film being applied during manufacturing, the user would be sold the ability to make the label at home.

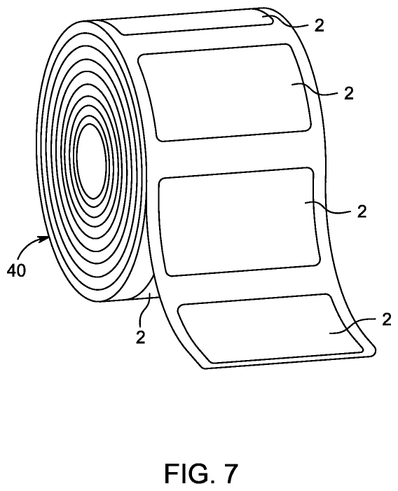

Various embodiments disclosed herein are directed to a roll of multi-layer adhering labels 2, comprising a plurality of multi-layer adhering label 2 according to any one of the embodiments herein carried by a roll of label liner (a/k/a label backing material) (FIG. 7).

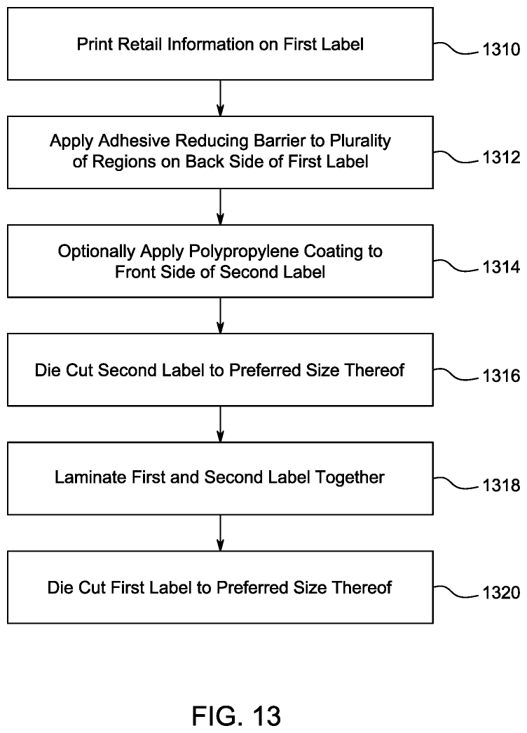

FIG. 13 shows an exemplary method of preparing a multi-layer adhering label 2, or a roll of multi-layer adhering labels 2 according to any one of the embodiments herein carried by a roll of label liner (a/k/a label backing material) as shown in FIG. 7). In some exemplary embodiments, label stock that already has adhesive on its back and carried by a backing material is provided for the first label. Retail information is printed on the removable first label 12 comprising an adhesive on the first back side 16 thereof according to any of the embodiments described above (step 1310). Next, the backing material for the first label is removed and an adhesive reducing barrier, such as silicone oil or varnish, is applied to certain regions of the first back side 16 of the removable first label 12 (step 1312). In exemplary embodiments, as described herein, the adhesive reducing barrier is applied to a plurality of regions on the first back side 16 of the removable first label 12 where the edge of the second label 18 will touch the removable first label 12 (see, e.g., FIGS. 6U-6X). In parallel with the preparation of the first label, the second is prepared. Label stock that already has adhesive on its back and carried by a backing material is provided for the second label. Optionally, a polypropylene coating is then applied to the second front side 20 of the second label 18 (step 1314). Next, the second label 18 is die cut to a preferred size thereof (step 1316). The removable first label 12 and second label 18 are then laminated together, by applying the removable first label 12 (backing material already removed and adhesive reducing barrier already applied) overtop the second label 18 onto the backing material of the second label, such that the removable first and second labels 12, 18 are now carried by the same label backing material (step 1318). Lastly, if needed, the removable first label 12 is die cut to a preferred size thereof (step 1320).

### EXAMPLES

Example 1—An exemplary multi-layer adhering label was made in the configuration of FIGS. 6A and 6L, with the second label being slightly smaller than and completely adhered to the removable first label. The removable first label was made of 54 #Synthetic paper, e.g., polypropylene with 0.06 mm thickness, and had a layer of acrylic solvent-based removable adhesive uniformly applied to the first back side of the removable first label. The removable first label had retail information pre-printed on the first front side. The second label was made of 54 # Synthetic paper, e.g., polypropylene with 0.06 mm thickness, and had a layer of acrylic solvent-based removable adhesive uniformly applied to the second back side of the second label. The entire front side of the second label was blank to create an area for writing with a writing instrument. The removable first label carried the second label. The two adhesives permitted the multi-layer adhering label to be adhered to a surface of bin made of transparent PET with the removable first label completely covering the second label. The first adhesive permitted the removable first label to be manually peelable by hand off of the bin and was replaceable in a different location on the bin. The second adhesive permitted the second label to be manually peelable by hand off of the bin and replaceable in a different location on the bin. The front of the second label permitted writing with a writing instrument, e.g., SHARPIE brand permanent ink. The front of the second label permitted the SHARPIE brand permanent ink to be removed with alcohol-based hand sanitizer (PURELL brand).

Example 2—The multi-layer adhering label of Example 1 was adhered to a surface of bin made of transparent PET with the removable first label completely covering the second label. The removable first label was manually peelable by hand off of the bin and was replaceable in a different location on the bin. The second label was manually peelable by hand off of the bin and was replaceable in a different location on the bin. The front of the second label permitted writing with a writing instrument, e.g., SHARPIE brand permanent ink. The front of the second label permitted the SHARPIE brand permanent ink to be removed with alcohol-based hand sanitizer (PURELL brand).

Example 3—An exemplary multi-layer adhering label was made in the configuration of FIGS. 6Q and 6R, with the second label 18 being slightly smaller than and completely adhered to the removable first label, except for a region of the removable first label without adhesive located over a corner of the second label (FIG. 6R). The removable first label was made of 54 # Synthetic paper, e.g., polypropylene with 0.06 mm thickness, and had a layer of acrylic solvent-based removable adhesive uniformly applied to the first back side of the removable first label, except for the region. The removable first label had retail information pre-printed on the front side. The removable first label also had pre-printed on the front side the words “peel here” on the front side proximate the corner corresponding to the region of the removable first label without adhesive located over the corner of the second label (FIG. 6R) to facilitate peeling the removable first label off of the second label without lifting the corresponding corner of the second label. The second label was made of 54 #Synthetic paper, e.g., polypropylene with 0.06 mm thickness, and had a layer of acrylic solvent-based removable adhesive uniformly applied to the second back side of the second label. The entire front side of the second label was blank to create an area for writing with a writing instrument. The removable first label carried the second label. The two adhesives permitted the multi-layer adhering label to be adhered to a surface of bin made of transparent PET with the removable first label completely covering the second label. The first adhesive permitted the removable first label to be manually peelable by hand off of the bin and was replaceable in a different location on the bin. The second adhesive permitted the second label to be manually peelable by hand off of the bin and replaceable in a different location on the bin. The front of the second label permitted writing with a writing instrument, e.g., SHARPIE brand permanent ink. The front of the second label permitted the SHARPIE brand permanent ink to be removed with alcohol-based hand sanitizer (PURELL brand).

Example 4—The multi-layer adhering label of Example 3 was adhered to a surface of bin made of transparent PET with the removable first label completely covering the second label. The removable first label was manually peelable by hand off of the bin (especially by peeling the corner marked “peel here”) and was replaceable in a different location on the bin. The second label was manually peelable by hand off of the bin and was replaceable in a different location on the bin. The front of the second label permitted writing with a writing instrument, e.g., SHARPIE brand permanent ink. The front of the second label permitted the SHARPIE brand permanent ink to be removed with alcohol-based hand sanitizer (PURELL brand).

Example 5—An exemplary multi-layer adhering label was made in the configuration of FIGS. 6C and 6N, with the second label 18 being smaller than the removable first label and unadhered to the first adhesive around the perimeter of the removable first label. The removable first label was made of 54 #Synthetic paper, e.g., polypropylene with 0.06 mm thickness, and had a layer of acrylic solvent-based removable adhesive applied to the perimeter of the first back side of the removable first label leaving a region without adhesive larger than the second label. The removable first label had retail information pre-printed on the front side. The second label was made of 54 #Synthetic paper, e.g., polypropylene with 0.06 mm thickness, and had a layer of acrylic solvent-based removable adhesive uniformly applied to the second back side of the second label. The entire second front side of the second label was blank to create an area for writing with a writing instrument. The removable first label did not carry the second label (in other exemplary embodiments, the removable first label carried the second label via static cling). The two adhesives permitted the multi-layer adhering label to be separately adhered to a surface of bin made of transparent PET with the removable first label completely covering the previously-applied second label. The first adhesive permitted the removable first label to be manually peelable by hand off of the bin and was replaceable in a different location on the bin. The second adhesive permitted the second label to be manually peelable by hand off of the bin and replaceable in a different location on the bin. The front of the second label permitted writing with a writing instrument, e.g., SHARPIE brand permanent ink. The second front side of the second label permitted the SHARPIE brand permanent ink to be removed with alcohol-based hand sanitizer (PURELL brand).

Example 6—The multi-layer adhering label of Example 5 was adhered to a surface of bin made of transparent PET with the removable first label completely covering the previously-applied second label with the second label in the region with no adhesive. The removable first label was manually peelable by hand off of the bin at any corner and was replaceable in a different location on the bin. The second label was manually peelable by hand off of the bin and was replaceable in a different location on the bin. The second front side of the second label permitted writing with a writing instrument, e.g., SHARPIE brand permanent ink. The front of the second label permitted the SHARPIE brand permanent ink to be removed with alcohol-based hand sanitizer (PURELL brand).

Example 7—An exemplary multi-layer adhering label was made in the configuration of FIGS. 6U and 6V, with the second label 18 being smaller than the removable first label. The removable first label was made of 54 #Synthetic paper, e.g., polypropylene with 0.06 mm thickness, and had a layer of acrylic solvent-based removable adhesive pre-applied to the entirety of the first back side, and further comprised eight (8) small regions of an applied adhesive reducing barrier such that the first adhesive was neutralized in said small regions corresponding to where the edge of the second label touches the first back side of the removable first label. The removable first label had retail information pre-printed on the front side. The second label was made of 54 # Synthetic paper, e.g., polypropylene with 0.06 mm thickness. The entire front side of the second label was blank to create an area for writing with a writing instrument. The removable first label carries the second label. The regions of adhesive reducing barrier permitted the removable first label to be removed from the second label without also carrying with it, and removing, any portion of the second label. The second adhesive permitted the second label to be manually peelable by hand off of the bin and replaceable in a different location on the bin. The front of the second label permitted writing with a writing instrument, e.g., SHARPIE brand permanent ink. The front of the second label permitted the SHARPIE brand permanent ink to be removed with alcohol-based hand sanitizer (PURELL brand).

Numerous other aspects, advantages, and/or features of the general inventive concepts will become more readily apparent from the following detailed description of exemplary embodiments, from the claims, and from the accompanying drawings being submitted herewith.

It will be appreciated that the scope of the general inventive concepts is not intended to be limited to the particular exemplary embodiments shown and described herein. From the disclosure given, those skilled in the art will not only understand the general inventive concepts and their attendant advantages but will also find apparent various changes and modifications to the methods and systems disclosed. It is sought, therefore, to cover all such changes and modifications as fall within the spirit and scope of the general inventive concepts, as described and claimed herein, and any equivalents thereof.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. For example, although the regions without adhesive 34, 36, 38 are shown as being rectangular, other shapes such as circles and ovals and irregular shapes can be used. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

### EXEMPLARY EMBODIMENTS

1. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument, wherein at least 50% of the second front side provides an area for writing with the writing instrument, wherein the writing can be removed, and wherein the second label includes means for attaching the second label to an object on at least part of the back side of the second label; and
wherein the first back side is adhered to, and removable from, the second front side, wherein the first back side covers at least a portion of the second front side of the second label and the removable first label carries the second label.

1B. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument, wherein at least 50% of the second front side provides an area for writing with the writing instrument, and wherein the second label includes means for attaching the second label to an object on at least part of the back side; and
wherein the first back side is adhered to, and removable from, the second front side, wherein the first back side covers at least a portion of the second label and the first label carries the second label; and
wherein the means for attaching the second label permits the second label to be removed from a surface of the object and repositioned on the same or another surface of the object (the same surface or a different surface of the object).

1C. A bin having a multi-layer adhering label affixed thereto, the multi-layer adhering label comprising:
a removable first label having a retail front side and a first back side, wherein the first back side includes a first adhesive on at least part of the first back side to adhere the removable first label to the bin;
a second label having a second front side and a second back side, wherein the second front side includes an outer surface capable of being written on with a writing instrument, wherein at least 50% of the second front side provides an area for writing with the writing instrument, wherein the writing can be removed, and wherein the second label includes means for attaching the second label to the bin on at least part of the second back side; and
wherein the removable first label at least partially covers the second front side of the second label.

1D. A bin having a multi-layer adhering label affixed thereto, the multi-layer adhering label comprising:
a removable first label having a retail front side and a first back side, wherein the first back side includes a first adhesive on at least part of the first back side to adhere the removable first label to the bin;
a second label having a second front side and a second back side, wherein the second front side includes an outer surface capable of being written on with a writing instrument, wherein at least 50% of the second front side provides an area for writing with the writing instrument, and wherein the second label includes means for attaching the second label to the bin on at least part of the back side; and
wherein the removable first label at least partially covers the second front side of the second label; and
wherein the means for attaching the second label permits the second label to be removed from a surface of the bin and repositioned on a surface of the bin (the same surface or a different surface of the object).

1E. A kit, comprising, a bin according to either of embodiments 1C or 1D, and further comprising instructions for a user to remove the removable first label from the bin and write on the second label, which is still on the bin.

1F. A roll of multi-layer adhering labels, comprising: a plurality of multi-layer adhering labels according to any one of the embodiments herein carried by a roll of label liner (a/k/a label backing material).

1G. A method for making a bin having a multi-layer adhering label affixed thereto, comprising:
providing a bin;
providing a multi-layer adhering label according to any one of the embodiments herein having a removable first label and a second label having a second front side and a second back side; and
adhering the multi-layer adhering label to a surface of the bin, with the removable first label adhered to the bin and covering at least a portion of the second front side of the second label.

1H. A method for making a bin having at least a removable first label and a second label, comprising:
attaching the second label to a surface of the bin, wherein the second label has a second front side and a second back side; and
removably adhering the removable first label to the surface of the bin, with the removable first label adhered to the bin and covering at least a portion of the second front side of the second label.

1J. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument, wherein at least 50% of the second front side provides an area for writing with the writing instrument, and wherein the second label includes means for attaching the second label to an object on at least part of the back side; and
wherein the first back side is adhered to, and removable from, the second front side, wherein the first back side covers at least a portion of the second label and the removable first label carries the second label; and
wherein the removable first label further comprises instructions for a user to remove the removable first label from the object (e.g., “peel here” or other instructions to remove the removable first label) printed on the retail front side of the removable first label (e.g., on a corner), permitting the user to write on the second label, which is still on the object.

1K. A bin having a multi-layer adhering label affixed thereto, the multi-layer adhering label comprising:
a removable first label having a retail front side and a first back side, wherein the first back side includes a first adhesive on at least part of the first back side to adhere the removable first label to the bin;
a second label having a second front side and a second back side, wherein the second front side includes an outer surface capable of being written on with a writing instrument, wherein at least 50% of the second front side provides an area for writing with the writing instrument, and wherein the second label includes means for attaching the second label to the bin on at least part of the back side; and
wherein the removable first label at least partially covers the second front side of the second label; and
wherein the removable first label further comprises instructions for a user to remove the removable first label from the bin (e.g., “peel here” or other instructions to remove the removable first label) printed on the retail front side of the removable first label (e.g., on a corner), permitting the user to write on the second label, which is still on the bin.

1L. The multi-layer adhering label or bin according to embodiment 1J or embodiment 1K, wherein the “peel here” or other instructions on the front side of the removable first label corresponds to a region of no adhesive, neutralized adhesive, less adhesive, or weaker adhesive on the first back side of the removable first label.

1M. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument, wherein at least 50% of the second front side provides an area for writing with the writing instrument, and wherein the second label includes means for attaching the second label to an object on at least part of the back side; and
wherein the first back side is adhered to, and removable from, at least one of the object or the second front side, wherein the first back side covers at least a portion of the second label and the removable first label carries the second label by means an electrostatic charge or cohesive force between the second front side and the first back side; and
wherein the means for attaching the second label permits the second label to be removed from a surface of the object and repositioned on the same or another surface of the object (the same surface or a different surface of the object).

1N. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument, wherein at least 50% of the second front side provides an area for writing with the writing instrument, wherein the writing can be removed, and wherein the second label includes means for attaching the second label to an object on at least part of the back side; and
wherein the first back side is adhered to, and removable from, at least one of the object or the second front side, wherein the first back side comprises at least one region of an adhesive reducing barrier proximate the second front side (e.g., at a location where the corners and/or edges of the second label are located when the two labels are attached); and
wherein the means for attaching the second label permits the second label to be removed from a surface of the object and repositioned on the same or another surface of the object (the same surface or a different surface of the object).

2. The multi-layer adhering label or method or bin or kit according to any one of the foregoing embodiments, wherein the area for writing comprises at least 50% of the area of the second front side.

3. The multi-layer adhering label or method or bin or kit according to any one of the foregoing embodiments, wherein the area for writing comprises a blank area that covers at least 50% of the area of the second front side.

4. The multi-layer adhering label or method or bin or kit according to any one of embodiments 1-1M, or 2, wherein the area for writing comprises some printing that is light enough so as not to obscure writing in black ink with a pen or permanent marker.

5. The multi-layer adhering label or method or bin or kit according to embodiment 4, wherein the printing comprises an image applied to the second label that is light enough so as not to obscure writing in black ink with a pen or permanent marker on the second front side of the second label.

6. The multi-layer adhering label or method or bin or kit according to embodiment 4, wherein the printing comprises a pattern applied to the second label that is light enough so as not to obscure writing in black ink with a pen or permanent marker on the second front side of the second label.

7. The multi-layer adhering label or method or bin or kit according to any one of the foregoing embodiments, wherein the first adhesive of the removable first label is removably adhered to at least 10% of the area of the second label second front side.

8. The multi-layer adhering label or method or bin or kit according to any one of the foregoing embodiments, wherein the entire second label second front side is adhered to, and removable from, the first adhesive of the removable first label.

9. The multi-layer adhering label or method or bin or kit according to any one of the foregoing embodiments, wherein the means for attaching the second label to an object comprises a second adhesive on at least part of the second back side.

10. The multi-layer adhering label or method or bin or kit according to embodiment 9, wherein the first and second adhesives are the same adhesive.

11. The multi-layer adhering label or method or bin or kit according to embodiment 9, wherein the first and second adhesives are the different and the second adhesive is stronger than the first adhesive.

12. The multi-layer adhering label or method or bin or kit according to any one of the foregoing embodiments, wherein the means for attaching the second label to an object comprises an electrostatic charge or cohesive force causing the second label to removably stick to a surface of the object wherein the surface is made from any of the following: polyethylene terephthalate, polypropylene, bio-resin, metal, powder-coated metal, wood, glass, or ceramic.

13. The multi-layer adhering label or method or bin or kit according to any one of the foregoing embodiments, wherein the area for writing of the second front side can be written on with permanent marker (e.g., SHARPIE brand) and wherein permanent marker writing can be removed from the second front side with a solvent.

14. The multi-layer adhering label or method or bin or kit according to any one of the foregoing embodiments, wherein the area for writing of the second front side can be written on with permanent marker (e.g., SHARPIE brand) and wherein permanent marker writing can be removed from the second front side with an alcohol-containing solvent, e.g., 70% or higher isopropyl alcohol.

15. The multi-layer adhering label or method or bin or kit according to embodiment 13, wherein the permanent marker writing can be removed from the second front side with an ethyl alcohol solvent.

16. The multi-layer adhering label or method or bin or kit according to embodiment 13, wherein the permanent marker writing can be removed from the second front side with solvent including at least one of: ethyl alcohol, isopropyl alcohol, caprylyl glycol, glycerin, isopropyl myristate, tocopheryl acetate, acrylates/C10-30 alkyl acrylate copolymer, aminomethyl Propanol.

17. The multi-layer adhering label or method or bin or kit according to any one of the foregoing embodiments, wherein the means for attaching the second label permits the second label to be removed from a surface of the object and repositioned on a surface of the object.

18. The multi-layer adhering label or method or bin or kit according to any one of the foregoing embodiments, wherein the removal of the permanent marker writing can be removed with a second object.

19. The multi-layer adhering label or method or bin or kit according to embodiment 18, wherein the second object is a rag.

20. The multi-layer adhering label or method or bin or kit according to embodiment 18, wherein the second object is a dry erase eraser.

21. The multi-layer adhering label or method or bin or kit according to any one of the foregoing embodiments, wherein the front side of the second label has a dry erase coating.

22. The multi-layer adhering label or method or bin or kit according to any one of the foregoing embodiments, wherein the front side of the second label has a composite coating made from recycled materials.

23. The multi-layer adhering label or method or bin or kit according to any one of the foregoing embodiments, wherein the removable first label fully covers the second front side of the second label.

24. The multi-layer adhering label or method or bin or kit according to any one of the foregoing embodiments, wherein the first adhesive is on only a perimeter of the first back side, or a portion of the perimeter of the first back side (e.g., only on the corners, only on the upper and lower edges, or only on left and right edges), leaving at least a central region of the first back side without adhesive.

25. The multi-layer adhering label or method or bin or kit according to any one of the foregoing embodiments, wherein the first adhesive is on only a perimeter of the first back side, or a portion of the perimeter of the first back side (e.g., only on the corners, upper and lower edges or only on left and right edges), leaving at least a central region of the first back side at least as large as the second label without adhesive so that the removable first label can cover the second front side of the second label without adhering thereto.

26. The multi-layer adhering label or method or bin or kit according to any one of the foregoing embodiments, wherein there is adhesive only on the outer corners of the first back side of the removable first label.

27. The multi-layer adhering label or method or bin or kit according to any one of the foregoing embodiments, wherein there is no adhesive on at least one of the corners of the first back side of the removable first label covering a portion of the second label so that when that corner is removed, no adhesive of the first back side lifts up a corresponding corner of the second label underneath.

28. The multi-layer adhering label or method or bin or kit according to any one of the foregoing embodiments, wherein there is no adhesive on the outer corners of the first back side of the removable first label covering a portion of the second label so that when any corner is removed, no adhesive of the first back side lifts up a corresponding corner of the second label underneath.

29. The multi-layer adhering label or method or bin or kit according to any one of the foregoing embodiments, wherein the second back side of the second label remains attached to the object after removing the removable first label from the object.

30. A kit according to embodiment 1E, wherein the instructions further comprise instructions for a user to remove and reposition the second label in another location on the bin.

31. A kit according to any one of embodiments 1E or 30, wherein the instructions are on the removable first label.

32. A kit according to any one of embodiments 1E or 30, wherein the instructions are on a sheet of instructions.

33. A kit according to any one of embodiments 1E or 30, wherein the instructions are on retail packaging for the bin.

34. A kit according to any one of embodiments 1E or 30, wherein the instructions are on packaging for the bin.

35. A kit according to any one of embodiments 1E or 30, wherein the instructions are on wrapping for the bin.

36. A kit according to any one of embodiments 1E or 30, wherein the instructions are on retail sales wrapping for the bin.

37. A method according to embodiment 1H, wherein attaching the second label to the surface of the bin comprises applying an electrostatic charge to the second back side so that the second label is removably held to the bin by a cohesive force.

38. A method according to embodiment 1H, wherein attaching the second label to the surface of the bin comprises applying an electrostatic charge to the second back side so that the second label is removably held to the bin by static cling force.

39. A method according to embodiment 1H, wherein attaching the second label to the surface of the bin comprises attaching the second label to the bin by cohesion.

40. A method according to embodiment 1H, wherein attaching the second label to the surface of the bin comprises removably attaching the second label to the bin by cohesion.

41. The multi-layer adhering label or method or bin or kit according to any one of the foregoing embodiments, wherein the removable first label is transparent, translucent, and/or opaque.

42. The multi-layer adhering label or method or bin or kit according to any one of the foregoing embodiments, wherein the removable first label is one of transparent, translucent, or opaque.

43. The multi-layer adhering label or method or bin or kit according to any one of the foregoing embodiments, wherein the second label is transparent, translucent, and/or opaque.

44. The multi-layer adhering label or method or bin or kit according to any one of the foregoing embodiments, wherein the second label is one of transparent, translucent, or opaque.

45. The multi-layer adhering label or method or bin or kit according to any one of the foregoing embodiments, wherein the first front side of the second label further comprises a polypropylene coating.

46. The multi-layer adhering label or method or bin or kit according to any one of the foregoing embodiments, wherein the removable first label comprises point of sale text.

47. The multi-layer adhering label or method or bin or kit according to any one of the foregoing embodiments, wherein the removable first label comprises point of sale text indicating at least a product description and a trademark.

48. The multi-layer adhering label or method or bin or kit according to any one of the foregoing embodiments, wherein the removable first label comprises point of sale text indicating one or more of: a product description, a trademark, and a product identifier (e.g., a product number and/or a UPC code), and also comprises a bar code.

49. The multi-layer adhering label or method or bin or kit according to any one of the foregoing embodiments, wherein a cohesive force is created between the second front side of the second label and the bin or object to which it is applied.

50. The multi-layer adhering label or method or bin or kit according to any one of the foregoing embodiments, wherein a cohesive force is created between the second front side of the second label and the first back side of the removable first label.

51. The multi-layer adhering label or method or bin or kit according to any one of the foregoing embodiments, wherein the second front side of the second label is removably attached to the first back side of the removable first label by static cling force before the removable first label is applied to the bin or object.

52. The multi-layer adhering label or method or bin or kit according to any one of the foregoing embodiments, wherein the second front side of the second label is removably attached to the first back side of the removable first label by static cling force after the removable first label is removed from the bin or object so that the second label can be removed from the removed removable first label and re-applied to the bin or object.

53. The multi-layer adhering label or method or bin or kit according to any one of the foregoing embodiments, wherein the second front side of the second label is removably attached to the first back side of the removable first label by static cling force before the removable first label is applied to the bin or object and after the removable first label removed from the bin or object so that the second label can be removed from the removed removable first label and re-applied to the bin or object.

54. The multi-layer adhering label or method or bin or kit according to any one of the foregoing embodiments, wherein the removable first label is removable and repositionable.

55. The multi-layer adhering label or method or bin or kit according to any one of the foregoing embodiments, wherein both the first and second labels are removable and repositionable.

56. The multi-layer adhering label or method or bin or kit according to any one of the foregoing embodiments, wherein the removable first label further comprises instructions for a user to remove the removable first label from the bin (e.g., “peel here” or other instructions to remove the removable first label) printed on the retail front side of the removable first label (e.g., on a corner), permitting the user to write on the second label, which is still on the object or bin.

57. The multi-layer adhering label or method or bin or kit according to any one of the foregoing embodiments, wherein the removable first label further comprises instructions for a user to remove the removable first label from the bin (e.g., “peel here” or other instructions to remove the removable first label) printed on the retail front side of the removable first label (e.g., on a corner), and further instructing the user to write on the second label, which is still on the object or bin.

58. The multi-layer adhering label or method or bin or kit according to any one of the foregoing embodiments having a region of the first back side without adhesive, wherein the region without adhesive is created by an adhesive reducing barrier applied to the back of the removable first label over a subset of the adhesive to create a region of the removable first label with a barrier between the adhesive and the second label to create a region of the removable first label that effectively has no adhesive (even though it does).

59. The multi-layer adhering label or method or bin or kit according to any one of the foregoing embodiments further comprising a region without adhesive created by an adhesive reducing barrier applied to the back of the removable first label over a subset of the adhesive to create a region of the removable first label with a barrier between the adhesive and the second label to create a region of the removable first label that effectively has no adhesive (even though it does).

60. The multi-layer adhering label or method or bin or kit according to any one of the foregoing embodiments, the removable first label further comprising a region of an adhesive reducing barrier applied to the back of the removable first label over a subset of the adhesive between the adhesive and the second label.

61. The multi-layer adhering label or method or bin or kit according to any one of the foregoing embodiments, the removable first label further comprising a region of an adhesive reducing barrier on the first back side of the removable first label over a subset of the adhesive between the adhesive and the second label proximate an outer edge of the second label, such that the outer edge of the second label is substantially within the region of the adhesive reducing barrier when the first label is adhered to the second label.

62. The multi-layer adhering label or method or bin or kit according to any one of the foregoing embodiments, the removable first label further comprising a plurality of regions of one or more of (i) no adhesive, (ii) reduced adhesive, (iii) neutralized adhesive, and/or (ii) an adhesive reducing barrier on the first back side of the removable first label, wherein the plurality of regions are located in a subset of the adhesive proximate an outer edge of the second label when the first label is adhered to the second label.

63. The multi-layer adhering label or method or bin or kit according to any one of the foregoing embodiments, the removable first label further comprising about 6-12 regions of one or more of (i) no adhesive, (ii) reduced adhesive, (iii) neutralized adhesive, and/or (ii) an adhesive reducing barrier on the first back side of the removable first label, wherein the plurality of regions are located in a subset of the adhesive proximate an outer edge of the second label when the first label is adhered to the second label.

64. The multi-layer adhering label or method or bin or kit according to any one of the foregoing embodiments, the removable first label further comprising about 8 regions of an adhesive reducing barrier on the first back side of the removable first label, wherein the plurality of regions are located proximate each corner of an outer edge of the second label, and along at least one of a top, bottom, and/or side of the outer edge of the second label when the first label is adhered to the second label.

65. The multi-layer adhering label or method or bin or kit according to any one of the foregoing embodiments, the second label further comprising a region of an adhesive reducing barrier on the second front side of the second label.

66. The multi-layer adhering label or method or bin or kit according to any one of the foregoing embodiments, the second label further comprising a plurality of regions of one or more of an adhesive reducing barrier on the second front side of the second label, wherein the plurality of regions are located proximate an outer edge of the second label when the first label is adhered to the second label.

67. The multi-layer adhering label or method or bin or kit according to any one of the foregoing embodiments, the second label further comprising about 6-12 regions of an adhesive reducing barrier on the second front side of the second label.

68. The multi-layer adhering label or method or bin or kit according to any one of the foregoing embodiments, the second label further comprising about 8 regions of an adhesive reducing barrier on the second front side of the second label, wherein the plurality of regions are located proximate each corner of an outer edge of the second label, and along at least one of a top, bottom, and/or side of the outer edge of the second label when the first label is adhered to the second label.

69. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side; and
wherein the first back side is adhered to, and removable from, the second front side;
wherein the first back side covers at least a portion of the second label, the first label carries the second label, and the first label is removable from the second label; and
wherein the area for writing of the second front side can be written on with permanent marker (e.g., SHARPIE brand) and wherein permanent marker writing can be removed from the second front side with a solvent.

70. The multi-layer adhering label of embodiment 69, wherein the second back side of the second label remains attached to the object after removing the removable first label from the object.

71. The multi-layer adhering label of any one of embodiments 69-70, wherein the second adhesive permits the second label to be removed from a surface of an object and repositioned on the same surface or another surface of the object.

72. The multi-layer adhering label of any one of embodiments 69-71, wherein the solvent capable of removing the permanent marker from the second front side comprises at least one of: ethyl alcohol, isopropyl alcohol, caprylyl glycol, glycerin, isopropyl myristate, tocopheryl acetate, acrylates/C10-30 alkyl acrylate copolymer, and aminomethyl Propanol.

73. The multi-layer adhering label of any one of embodiments 69-72, wherein there is no adhesive, or there is reduced adhesive, neutralized adhesive, or an adhesive reducing barrier, or some other means for reducing adhesion between the first and second labels, on at least a corner of the first back side of the removable first label.

74. The multi-layer adhering label of embodiment any one of embodiments 69-73, wherein the removable first label comprises point of sale text on its retail front side.

75. The multi-layer adhering label of embodiment any one of embodiments 69-74, wherein the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label.

76. The multi-layer adhering label of embodiment any one of embodiments 69-75, wherein the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label.

77. The multi-layer adhering label of embodiment any one of embodiments 69-76, wherein the 6-12 regions of an adhesive reducing barrier on the first back side of the removable first label are spaced from the outer edge of the first label, and wherein four of the regions are located over a respective corner of the second label and other of the regions are located over one or more edges of the second label when the first label is adhered to the second label.

78. A bin having a multi-layer adhering label affixed thereto, the multi-layer adhering label comprising:
a removable first label having a retail front side and a first back side, wherein the first back side includes a first adhesive on at least part of the first back side to adhere the removable first label to the bin;
a second label having a second front side and a second back side, wherein the second front side includes an outer surface capable of being written on with a writing instrument, wherein at least 50% of the second front side provides an area for writing with the writing instrument, and wherein the second label includes means for attaching the second label to the bin on at least part of the back side; and
wherein the removable first label and the second label are affixed to the bin, with the removable first label at least partially covering the second front side of the second label, and further wherein the first label is removable from the bin and the second label, leaving the second label affixed to the bin; and
wherein the area for writing of the second front side can be written on with permanent marker (e.g., SHARPIE brand) and wherein permanent marker writing can be removed from the second front side with a solvent.

79. The bin of embodiment 78, wherein the second back side of the second label remains attached to the bin after removing the removable first label from the bin.

80. The bin of any one of embodiments 78-79, wherein the means for attaching the second label permits the second label to be removed from a surface of the bin and repositioned on a surface of the bin (the same surface or a different surface of the bin).

81. The bin of any one of embodiments 78-80, wherein the solvent capable of removing the permanent marker from the second front side comprises at least one of: ethyl alcohol, isopropyl alcohol, caprylyl glycol, glycerin, isopropyl myristate, tocopheryl acetate, acrylates/C10-30 alkyl acrylate copolymer, and aminomethyl Propanol.

82. The bin of any one of embodiments 78-81, wherein there is no adhesive, or there is reduced adhesive, neutralized adhesive, or an adhesive reducing barrier, or some other means for reducing adhesion between the first and second labels, on at least a corner of the first back side of the removable first label.

83. The bin of any one of embodiments 78-82, wherein the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label.

84. The bin of any one of embodiments 78-83, wherein the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label.

85. The bin of any one of embodiments 78-84, wherein the 6-12 regions of an adhesive reducing barrier on the first back side of the removable first label are spaced from the outer edge of the first label, and wherein four of the regions are located over a respective corner of the second label and other of the regions are located over one or more edges of the second label when the first label is adhered to the second label.

86. A kit, comprising a bin according to any one of embodiments 78-85, and further comprising instructions for a user to remove the removable first label from the bin and write on the second label, which is still on the bin.

87. A kit, comprising a bin having a multi-layer adhering label according to any one of embodiments 69-77 affixed thereto, and further comprising instructions for a user to remove the removable first label from the bin and write on the second label, which is still on the bin.

88. A multi-layer adhering label, comprising:
a removable first label having a retail front side and a first back side, wherein the first back side includes a first adhesive on the first back side;
a second label having a second front side and a second back side, wherein the second front side includes an outer surface capable of being written on with a writing instrument, wherein at least 50% of the second front side comprises an area for writing with the writing instrument, and wherein the second label includes a second adhesive on the second back side; and
wherein the area for writing of the second front side can be written on with permanent marker (e.g., SHARPIE brand) and wherein permanent marker writing can be removed from the second front side with a solvent;
wherein the first back side is adhered to, and removable from, the second front side;
wherein the first back side covers the second label and the first label carries the second label;
wherein the removable first label further comprises a plurality of regions of an adhesive reducing barrier on the first back side of the removable first label, wherein the plurality of regions are located in a subset of the first adhesive proximate an outer edge of the second label when the first label is adhered to the second label;
wherein the means for attaching the second label permits the second label to be removed from a surface of the object and repositioned on the same or another surface of the object (the same surface or a different surface of the object).

89. A method for making a bin having a multi-layer adhering label affixed thereto, comprising:
providing a bin;
providing a multi-layer adhering label according to any one of embodiments 69-77 and
adhering the multi-layer adhering label to a surface of the bin, with the removable first label adhered to the bin and covering at least a portion of the second front side of the second label.

90. A method for preparing a multi-layer adhering label, comprising:
providing a removable first label having a retail front side and a first back side, wherein the first back side includes a first adhesive on at least a part of the first back side;
applying an adhesive reducing barrier to at least one of a region of adhesive on the first back side of the removable first label;
providing a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side; and
laminating the removable first label and second label together by applying the removable first label overtop the second label, such that the removable first label carries the second label.

91. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side; and
wherein the first back side is adhered to, and removable from, the second front side;
wherein the first back side covers at least a portion of the second label, the first label carries the second label, and the first label is removable from the second label; and
wherein the area for writing of the second front side can be written on with permanent marker (e.g., SHARPIE brand) and wherein permanent marker writing can be removed from the second front side with a solvent.

92. The multi-layer adhering label of embodiment 91, wherein the second back side of the second label remains attached to the object after removing the removable first label from the object.

93. The multi-layer adhering label according to any one of embodiments 91-92, wherein the second adhesive permits the second label to be removed from a surface of an object and repositioned on the same surface or another surface of the object.

94. The multi-layer adhering label according to any one of embodiments 91-93, wherein the solvent capable of removing the permanent marker from the second front side comprises at least one of: ethyl alcohol, isopropyl alcohol, caprylyl glycol, glycerin, isopropyl myristate, tocopheryl acetate, acrylates/C10-30 alkyl acrylate copolymer, and aminomethyl Propanol.

95. The multi-layer adhering label according to any one of embodiments 91-94, wherein there is no adhesive, or there is reduced adhesive, neutralized adhesive, or an adhesive reducing barrier, or some other means for reducing adhesion between the first and second labels, on at least a corner of the first back side of the removable first label.

96. The multi-layer adhering label according to any one of embodiments 91-95, wherein the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label.

97. The multi-layer adhering label according to any one of embodiments 91-96, wherein the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label.

98. The multi-layer adhering label according to any one of embodiments 91-97, wherein the 6-12 regions of an adhesive reducing barrier on the first back side of the removable first label are spaced from the outer edge of the first label, and wherein four of the regions are located over a respective corner of the second label and other of the regions are located over one or more edges of the second label when the first label is adhered to the second label.

99. A bin with a multi-layer adhering label from any one of embodiments 91-98 affixed thereto.

100. A kit, comprising:
a bin; and
a multi-layer adhering label according to any one of embodiments 91-98 affixed to the bin; and
instructions for a user to remove a removable first label from the bin and write on the second label, which is still on the bin.

101. A method for making a bin having a multi-layer adhering label affixed thereto, comprising:
providing a bin;
providing a multi-layer adhering label according to any one of embodiment 91-98; and
adhering the multi-layer adhering label to a surface of the bin, with the removable first label adhered to the bin and covering at least a portion of the second front side of the second label.

102. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side; and
wherein the first back side is adhered to, and removable from, the second front side;
wherein the first back side covers at least a portion of the second label, the first label carries the second label, and the first label is removable from the second label; and
wherein the second adhesive permits the second label to be removed from a surface of an object and repositioned on the same surface or another surface of the object.

103. The multi-layer adhering label of embodiment 102, wherein the second back side of the second label remains attached to the object after removing the removable first label from the object.

104. The multi-layer adhering label of any one of embodiments 102-103, wherein the area for writing of the second front side can be written on with permanent marker (e.g., SHARPIE brand) and wherein permanent marker writing can be removed from the second front side with a solvent.

105. The multi-layer adhering label of any one of embodiments 102-104, wherein the solvent capable of removing the permanent marker from the second front side comprises at least one of: ethyl alcohol, isopropyl alcohol, caprylyl glycol, glycerin, isopropyl myristate, tocopheryl acetate, acrylates/C10-30 alkyl acrylate copolymer, and aminomethyl Propanol.

106. The multi-layer adhering label of any one of embodiments 102-105, wherein there is no adhesive, or there is reduced adhesive, neutralized adhesive, or an adhesive reducing barrier, or some other means for reducing adhesion between the first and second labels, on at least a corner of the first back side of the removable first label.

107. The multi-layer adhering label of any one of embodiments 102-106, wherein the removable first label comprises point of sale text on its retail front side.

108. The multi-layer adhering label of any one of embodiments 102-107, wherein the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label.

109. The multi-layer adhering label of embodiment any one of embodiments 102-108, wherein the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label.

110. The multi-layer adhering label of any one of embodiments 102-109, wherein the 6-12 regions of an adhesive reducing barrier on the first back side of the removable first label are spaced from the outer edge of the first label, and wherein four of the regions are located over a respective corner of the second label and other of the regions are located over one or more edges of the second label when the first label is adhered to the second label.

111. A bin having a multi-layer adhering label affixed thereto, the multi-layer adhering label comprising:
a removable first label having a retail front side and a first back side, wherein the first back side includes a first adhesive on at least part of the first back side to adhere the removable first label to the bin;
a second label having a second front side and a second back side, wherein the second front side includes an outer surface capable of being written on with a writing instrument, wherein at least 50% of the second front side provides an area for writing with the writing instrument, and wherein the second label includes means for attaching the second label to the bin on at least part of the back side; and
wherein the removable first label and the second label are affixed to the bin, with the removable first label at least partially covering the second front side of the second label, and further wherein the first label is removable from the bin and the second label, leaving the second label affixed to the bin; and
wherein the means for attaching the second label permits the second label to be removed from a surface of the bin and repositioned on a surface of the bin (the same surface or a different surface of the bin).

112. The bin of embodiment 111, wherein the second back side of the second label remains attached to the bin after removing the removable first label from the bin.

113. The bin of any one of embodiments 111-112, wherein the area for writing of the second front side can be written on with permanent marker (e.g., SHARPIE brand) and wherein permanent marker writing can be removed from the second front side with a solvent, wherein the solvent capable of removing the permanent marker from the second front side comprises at least one of: ethyl alcohol, isopropyl alcohol, caprylyl glycol, glycerin, isopropyl myristate, tocopheryl acetate, acrylates/C10-30 alkyl acrylate copolymer, and aminomethyl Propanol.

114. The bin of any one of embodiments 111-113, wherein there is no adhesive, or there is reduced adhesive, neutralized adhesive, or an adhesive reducing barrier, or some other means for reducing adhesion between the first and second labels, on at least a corner of the first back side of the removable first label.

115. The bin of any one of embodiments 111-114, wherein the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label.

116. The bin of any one of embodiments 111-115, wherein the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label.

117. The bin of any one of embodiments 111-116, wherein the 6-12 regions of an adhesive reducing barrier on the first back side of the removable first label are spaced from the outer edge of the first label, and wherein four of the regions are located over a respective corner of the second label and other of the regions are located over one or more edges of the second label when the first label is adhered to the second label.

118. A kit, comprising a bin according to any one of embodiments 111-116, and further comprising instructions for a user to remove the removable first label from the bin and write on the second label, which is still on the bin.

119. A kit, comprising a bin having a multi-layer adhering label according to any one of embodiments 102-110 affixed thereto, and further comprising instructions for a user to remove the removable first label from the bin and write on the second label, which is still on the bin.

120. A multi-layer adhering label, comprising:
a removable first label having a retail front side and a first back side, wherein the first back side includes a first adhesive on the first back side;
a second label having a second front side and a second back side, wherein the second front side includes an outer surface capable of being written on with a writing instrument, wherein at least 50% of the second front side comprises an area for writing with the writing instrument, and wherein the second label includes a second adhesive on the second back side; and
wherein the area for writing of the second front side can be written on with permanent marker (e.g., SHARPIE brand) and wherein permanent marker writing can be removed from the second front side with a solvent;
wherein the first back side is adhered to, and removable from, the second front side;
wherein the first back side covers the second label and the first label carries the second label;
wherein the removable first label further comprises a plurality of regions of an adhesive reducing barrier on the first back side of the removable first label, wherein the plurality of regions are located in a subset of the first adhesive proximate an outer edge of the second label when the first label is adhered to the second label;
wherein the means for attaching the second label permits the second label to be removed from a surface of the object and repositioned on the same or another surface of the object (the same surface or a different surface of the object).

121. A method for making a bin having a multi-layer adhering label affixed thereto, comprising:
providing a bin;
providing a multi-layer adhering label according to any one of embodiments 102-110; and
adhering the multi-layer adhering label to a surface of the bin, with the removable first label adhered to the bin and covering at least a portion of the second front side of the second label.

122. A method for preparing a multi-layer adhering label, comprising:
providing a removable first label having a retail front side and a first back side, wherein the first back side includes a first adhesive on at least a part of the first back side;
applying an adhesive reducing barrier to at least one of a region of adhesive on the first back side of the removable first label;
providing a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side; and
laminating the removable first label and second label together by applying the removable first label overtop the second label, such that the removable first label carries the second label.

123. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side; and
wherein the first back side is adhered to, and removable from, the second front side;
wherein the first back side covers at least a portion of the second label, the first label carries the second label, and the first label is removable from the second label; and
wherein the second adhesive permits the second label to be removed from a surface of an object and repositioned on the same surface or another surface of the object.

124. The multi-layer adhering label of embodiment 123, wherein the second back side of the second label remains attached to the object after removing the removable first label from the object.

125. The multi-layer adhering label according to any one of embodiments 123-124, wherein the area for writing of the second front side can be written on with permanent marker (e.g., SHARPIE brand) and wherein permanent marker writing can be removed from the second front side with a solvent, and wherein the solvent capable of removing the permanent marker from the second front side comprises at least one of: ethyl alcohol, isopropyl alcohol, caprylyl glycol, glycerin, isopropyl myristate, tocopheryl acetate, acrylates/C10-30 alkyl acrylate copolymer, and aminomethyl Propanol.

126. The multi-layer adhering label according to any one of embodiments 123-125, wherein there is no adhesive, or there is reduced adhesive, neutralized adhesive, or an adhesive reducing barrier, or some other means for reducing adhesion between the first and second labels, on at least a corner of the first back side of the removable first label.

127. The multi-layer adhering label according to any one of embodiments 123-126, wherein the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label.

128. The multi-layer adhering label according to any one of embodiments 123-127, wherein the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label.

129. The multi-layer adhering label according to any one of embodiments 123-128, wherein the 6-12 regions of an adhesive reducing barrier on the first back side of the removable first label are spaced from the outer edge of the first label, and wherein four of the regions are located over a respective corner of the second label and other of the regions are located over one or more edges of the second label when the first label is adhered to the second label.

130. A bin with a multi-layer adhering label from any one of embodiments 123-129 affixed thereto.

131. A kit, comprising:
a bin; and
a multi-layer adhering label according to any one of embodiments 123-129 affixed to the bin; and
instructions for a user to remove a removable first label from the bin and write on the second label, which is still on the bin.

132. A method for making a bin having a multi-layer adhering label affixed thereto, comprising:
providing a bin;
providing a multi-layer adhering label according to any one of embodiment 123-129; and
adhering the multi-layer adhering label to a surface of the bin, with the removable first label adhered to the bin and covering at least a portion of the second front side of the second label.

1. A multi-layer adhering label, comprising:
a removable first label having a retail front side and a first back side, wherein the first back side includes a first adhesive on at least part of the first back side;
a second label having a second front side and a second back side, wherein the second front side includes an outer surface capable of being written on with a writing instrument,
wherein the second front side comprises an area for writing with the writing instrument, and wherein the second label includes a second adhesive on at least part of the second back side;
wherein the first back side is adhered to, and removable from, the second front side;
wherein the first back side covers at least a portion of the second label, the first label carries the second label, and the first label is removable from the second label; and
wherein the area for writing of the second front side can be written on with permanent marker (e.g., SHARPIE brand) and wherein permanent marker writing can be removed from the second front side with a solvent.

2. The multi-layer adhering label of claim 1, wherein the second back side of the second label remains attached to the object after removing the removable first label from the object.

3. The multi-layer adhering label of claim 1, wherein the second adhesive permits the second label to be removed from a surface of an object and repositioned on the same surface or another surface of the object.

4. The multi-layer adhering label of claim 1, wherein the second front side of the second label is blank.

5. The multi-layer adhering label of claim 1, wherein the removable first label further comprises instructions for a user to remove the removable first label from the bin (e.g., “peel here” or other instructions to remove the removable first label, printed on the removable first label itself such as on a corner), permitting the user to write on the second label, which is still on the bin.

6. The multi-layer adhering label of claim 1, wherein the removable first label comprises point of sale text on its retail front side.

7. The multi-layer adhering label of claim 1, wherein the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label.

8. The multi-layer adhering label of claim 7, wherein the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label.

9. The multi-layer adhering label of claim 8, wherein the 6-12 regions of an adhesive reducing barrier on the first back side of the removable first label, wherein four of the regions are located over a respective corner of the second label and other of the four regions are located over one or more edges of the second label when the removable first label is adhered to the second label, and wherein the removable first label completely covers the second label.

10. A bin having a multi-layer adhering label affixed thereto, the multi-layer adhering label comprising:
a removable first label having a retail front side and a first back side, wherein the first back side includes a first adhesive on at least part of the first back side to adhere the removable first label to the bin;
a second label having a second front side and a second back side, wherein the second front side includes an outer surface capable of being written on with a writing instrument, wherein the second front side provides an area for writing with the writing instrument, and wherein the second label includes means for attaching the second label to the bin on at least part of the back side; and
wherein the removable first label and the second label are affixed to the bin, with the removable first label at least partially covering the second front side of the second label, and further wherein the first label is removable from the bin and the second label, leaving the second label affixed to the bin; and
wherein the area for writing of the second front side can be written on with permanent marker (e.g., SHARPIE brand) and wherein permanent marker writing can be removed from the second front side with a solvent.

11. The bin of claim 10, wherein the second back side of the second label remains attached to the bin after removing the removable first label from the bin.

12. The bin of claim 10, wherein the means for attaching the second label permits the second label to be removed from a surface of the bin and repositioned on a surface of the bin (the same surface or a different surface of the bin).

13. The bin of claim 10, wherein the second front side of the second label is blank.

14. The bin of claim 10, wherein the removable first label further comprises instructions for a user to remove the removable first label from the bin printed on the removable first label itself such as on a corner, permitting the user to write on the second label, which is still on the bin.

15. The bin of claim 10, wherein the removable first label further comprises a plurality of regions of one or more of: (i) no adhesive, (ii) a reduced adhesive, (iii) a neutralized adhesive, and/or (ii) an adhesive reducing barrier on the first back side of the removable first label, and wherein the plurality of regions are located in a subset of the first adhesive over an outer edge of the second label when the first label is adhered to the second label.

16. The bin of claim 15, wherein the removable first label comprises about 6-12 regions of an adhesive reducing barrier on the first back side of the removable first label, and wherein one of the regions is located over at least one corner of the second label and another of the regions is located over an outer edge of the second label when the first label is adhered to the second label.

17. The bin of claim 16, wherein the 6-12 regions of an adhesive reducing barrier on the first back side of the removable first label, wherein four of the regions are located over a respective corner of the second label and other of the four regions are located over one or more edges of the second label when the removable first label is adhered to the second label, and wherein the removable first label completely covers the second label.

18. A kit, comprising a bin having a multi-layer adhering label according to claim 1 affixed thereto, and further comprising instructions for a user to remove the removable first label from the bin and write on the second label, which is still on the bin.

19. A method for making a bin having a multi-layer adhering label affixed thereto, comprising:
providing a bin;
providing a multi-layer adhering label according to claim 1; and
adhering the multi-layer adhering label to a surface of the bin, with the removable first label adhered to the bin and covering at least a portion of the second front side of the second label.

20. A method for preparing a multi-layer adhering label, comprising:
providing a removable first label having a retail front side and a first back side, wherein the first back side includes a first adhesive on at least a part of the first back side;
applying an adhesive reducing barrier to at least one of a region of adhesive on the first back side of the removable first label;
providing a second label having a second front side and a second back side, wherein the second front side includes an outer surface capable of being written on with a writing instrument, wherein at least 50% of the second front side comprises an area for writing with the writing instrument, and wherein the second label includes a second adhesive on at least part of the second back side; and
laminating the removable first label and second label together by applying the removable first label overtop the second label, such that the removable first label carries the second label.
